(19) United States
(12) Patent Application Publication
(10) Pub. No.: US 2026/0039938 A1
(43) Pub. Date: Feb. 5, 2026

(54) ATTACHMENT SYSTEMS FOR CAMERA LENS ASSEMBLIES

(71) Applicant: GoPro, Inc., San Mateo, CA (US)

(72) Inventors: David Thomas Platner, San Francisco, CA (US); Nicholas Vitale, Foster City, CA (US); Ian Copeland Griggs, San Francisco, CA (US); Jonathan Michael Stern, San Mateo, CA (US)

(21) Appl. No.: 18/788,682

(22) Filed: Jul. 30, 2024

(51) Int. Cl. H04N 23/54; H04N 23/51; H04N 23/55

(52) U.S. Cl. CPC H04N 23/54; H04N 23/51; H04N 23/55

(57) ABSTRACT

An image capture device includes a body, an image sensor and lens assembly (ISLA), an insert, and a fastener. The body defines an interior and an exterior. The ISLA is located partly or entirely within the body. The ISLA includes a housing that extends from an image sensor to a lens to define an optical axis. The insert extends partially or entirely into the housing of the ISLA. The fastener is configured to extend from the exterior of the body in a direction parallel with the optical axis and engage the insert to connect the ISLA to the body.

### TECHNICAL FIELD

This disclosure relates to attachment and shielding systems for image capture devices. More specifically, this disclosure relates to attachment systems for securing image sensor and lens assemblies within image capture devices and to shielding systems that reducing and/or eliminate electromagnetic interference between electronic components of image capture devices.

### BACKGROUND

Image capture devices are used in a variety of applications, including, for example, handheld camera and video recorders, cell phones, drones, vehicles, etc. Image capture devices typically include an optical module with one or more lenses (optical elements), which capture content by receiving and focusing light, and one or more image sensors, which convert the captured content into an electronic image signal that is processed by an image signal processor to form an image. In some image capture devices, the lens(es) and the image sensor(s) are supported by a housing such that the lens(es) and the image sensor(s) are combined into a single unit, which is known as an image sensor and lens assembly (ISLA).

The housing of an ISLA may be secured to structural components of the image capture device (e.g., a body) using one or more fasteners. Often, the housing of the ISLA and structural components of the image capture device have different properties (e.g., material properties, geometries, etc.) which may make certain fastener configurations more desirable than others. For example, certain fastener configurations may provide a more robust connection between the ISLA and the body of the image capture device than others. Achieving desirable fastener configurations may be difficult due to packaging constraints and the like.

Furthermore, omnidirectional image capture devices that include a pair of ISLAs often orient the pair of ISLAs in opposite (e.g., front and rear) directions that place electronic components (e.g., image sensors) of the ISLAs in close proximity to one another. Placing electronic components in close proximity to one another may increase the risk that the electronic components be subjected to electromagnetic interference (EMI).

Furthermore, image capture devices that include multiple lenses may include one or more lenses on an ISLA and one or more lenses on other components of the image capture device (e.g., a body). The lens(es) of the ISLA and the lens(es) of the other components may be spaced from one-another to define one or more gaps therebetween. The size of the gap(s) may affect optical characteristics of the image capture device. The composition of the ISLA and the other components of the image capture device may influence the size of the gap(s).

### SUMMARY

In a first aspect, an image capture device includes a body and an image sensor and lens assembly (ISLA). The body defines an interior and an exterior, and the ISLA is located partly or entirely within the interior of the body. The ISLA comprises a housing that extends from an image sensor to a lens to define an optical axis. The image capture device also includes an insert and a fastener. The insert extends partially or entirely into the housing of the ISLA and the fastener is configured to extend from the exterior of the body in a direction parallel with the optical axis and engage the insert to connect the ISLA to the body.

In a second aspect, an image capture device includes a body and an image sensor and lens assembly (ISLA) located either partly or entirely within an interior of the body. The ISLA comprises a housing that includes a rear surface. The image capture device also includes a fastener that is configured to extend from an exterior of the body, through the housing to engage an insert located on the rear surface of the housing to connect the housing to the body. The housing of the ISLA includes an anti-rotation device that is configured to receive and inhibit rotation of the insert.

In a third aspect, an attachment system includes an image capture device and an anti-rotation device. The image capture device includes a body and an image sensor and lens assembly (ISLA) that is configured to be secured within the body. The ISLA includes a housing that includes a rear surface. The image capture device also includes an insert that is positionable on the rear surface of the housing. The insert is configured to receive a fastener that extends from an exterior of the body and through the housing to secure the ISLA within the body. The anti-rotation device is positionable on the rear surface of the housing to receive and inhibit rotation of the insert.

In a fourth aspect, an image capture device includes a first and second image sensor and lens assembly (ISLA) and a shielding system. The first ISLA and the second ISLA face opposite directions and are positioned along a common longitudinal axis. Each of the first ISLA and the second ISLA include an image sensor and a lens, in which the image sensor and the lens are positioned along the common longitudinal axis. The shielding system is located between the image sensor of the first ISLA and the image sensor of the second ISLA. The shielding system is configured to absorb electromagnetic radiation that has a frequency within a range.

In some implementations, the shielding system includes a horizontal shield and one or more perpendicular shields. The horizontal shield is located between the image sensor of the first ISLA and the image sensor of the second ISLA. The one or more perpendicular shields are located on respective lateral sides of at least one of the image sensor of the first ISLA or the image sensor of the second ISLA.

In a fifth aspect, an image capture device includes a body, a first image sensor and lens assembly (ISLA), a second ISLA, and a shim. The body defines an interior and an exterior and includes a first body lens and a second body lens. The first ISLA is located partially or entirely within the interior of the body and includes a first ISLA lens that is positioned adjacent to the first body lens a long a first optical axis. The second ISLA is also located partly or entirely within the interior of the body. The second ISLA lens is positioned adjacent to the second body lens along a second optical axis to define an air gap between the second ISLA lens and the second body lens. The second ISLA is connected to the body by the first ISLA. The shim is located between the first ISLA and the second ISLA and is configured to adjust a size of the air gap along the second optical axis.

In some implementations, the first body lens and the second body lens are located on opposite sides of the body, and the first ISLA and the second ISLA face opposite directions.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture device.

FIGS. 2A-2B are isometric views of another example of an image capture device.

FIG. 3 is a top view of another example of an image capture device.

FIGS. 4A-4B are isometric views of another example of an image capture device.

FIG. 5 is a block diagram of electronic components of an image capture device.

FIG. 6 is an isometric view of another example of an image capture device that includes an attachment system.

FIG. 7 is a sectional view of an image sensor and lens assembly (ISLA) that includes the attachment system of FIG. 6.

FIG. 8 is a cross-sectional view of the attachment system of FIG. 6.

FIGS. 9A-9C are isometric views of inserts for the attachment system of FIG. 6.

FIG. 10 is a sectional view of the ISLA of FIG. 7 that include an attachment system.

FIG. 11 is an isometric view of the ISLA and the attachment system of FIG. 7.

FIGS. 12A-12B are isometric views of the ISLA of FIG. 7 that includes an attachment system.

FIG. 13 is an isometric view of the ISLA of FIG. 7 that includes an attachment system.

FIGS. 14A-14B are sectional views of an ISLA that includes an attachment system.

FIG. 15 is an isometric view of a housing of the ISLA of FIG. 14A that includes an attachment system.

FIG. 16 is an isometric view of the housing of the ISLA of FIG. 14A that includes an attachment system.

FIG. 17 is an isometric view of the housing of the ISLA of FIG. 14A that includes an attachment system.

FIG. 18 is a sectional view of the ISLA of FIG. 14A that includes an attachment system.

FIG. 19 is an isometric view of the housing of the ISLA of FIG. 14A that includes a sealing system.

FIGS. 20A-20C are isometric views of the housing of the ISLA of FIG. 14A for the sealing system of FIG. 19.

FIGS. 21A-21B are isometric views of a pair of ISLAs for an omnidirectional image capture device.

FIGS. 22A-22B are isometric views of a shielding system for the pair of ISLAs of FIGS. 21A-21B.

FIG. 23 is a cross-sectional view of an example of an omnidirectional image capture device that includes the pair of ISLAs of FIGS. 21A-21B.

FIG. 24 is an exploded view of a shim system for the omnidirectional image capture device of FIG. 23.

### DETAILED DESCRIPTION

The present disclosure describes image capture devices with improved attachment systems for connecting an image sensor and lens assembly (ISLA) to structural components (e.g., a body) of an image capture device. As indicated above, fasteners may be used to connect an ISLA to structural components of the image capture device. Some fastener configurations may provide a more robust connection between the ISLA and the structural components than other configurations based on the properties of the ISLA and the structural components. For example, an ISLA may include a housing that supports a lens and an image sensor. The housing, therefore, may comprise a material having certain properties (e.g., high stiffness, high reflectivity, etc.) that promote controlled light travel from the lens to the image sensor. Such a material, however, may lack other properties (e.g., toughness, etc.) that enable robust engagement with a threaded fastener. Other structural components of the image capture device, on the other hand, may comprise other materials that have properties that enable robust engagement with a threaded fastener.

Accordingly, to achieve a robust connection, fastener configurations are often employed in which a threaded fastener captures the housing of the ISLA by extending through the housing and into structural components of the image capture device (e.g., the body) without threads directly engaging the housing. Achieving such fastener configurations, however, may require fastener insertion trajectories that are difficult to access (e.g., trajectories from an interior the image capture device). Thus, attachment systems may be desired that enable the use of easier to access fastener insertion trajectories while providing a robust connection between the ISLA and the structural components of the image capture device. As is described herein, such attachment systems may include inserts that enable fastener insertion trajectories into the housing of the ISLA (e.g., from an exterior of the image capture device) while providing a robust connection.

The present disclosure also describes image capture devices with improved shielding systems for protecting electronic components of an image capture device from electromagnetic interference (EMI). Electronic components may emit electromagnetic radiation that can interrupt the intended operation of (e.g., may cause noise in signals of) other electronic components, especially electronic components that are in close proximity to the source of the electromagnetic radiation. This effect may be referred to as EMI. As indicated above, omnidirectional image capture devices often orient a pair of ISLAs such as to position electronic components (e.g., image sensors) in close proximity to one another.

To reduce or prevent EMI, shielding may be placed between the source of the electromagnetic radiation and the affected electronic component. The shielding may have certain properties (e.g., electrical conductivity, magnetic permeability, etc.) that enables the shielding to absorb certain frequencies of electromagnetic radiation and thus inhibit such radiation from interfering with the affected electronic component.

Furthermore, the present disclosure describes image capture devices with shim systems for maintaining a nominal gap between lenses. Some image capture devices include one or more lenses on an external component of the image capture device (e.g., a body) that are in optical communication with one or more lenses of an ISLA to form an optical system of the image capture device. Such image capture devices may space the lens(es) of the body from the lens(es) of the ISLA along an optical axis of the image capture device. The space between the inner-most lens of the external component of the image capture device and the outer-most lens of the ISLA may be referred to as an air gap. The size of the air gap (e.g., the distance between lenses along the optical axis) may influence the optical characteristics of the optical system, such as by influencing the focal point of light that travels through the optical system. Accordingly, a nominal size for the air gap may be established that results in nominal (e.g., optimal) optical characteristics for the optical system. Deviations from the nominal size of the air gap—and thus the optical characteristics of the optical system—may thereby result in defects in the images captured by the image capture device.

The tolerances of components that connect the lens(es) of the ISLA to the lens(es) of the external component of the image capture device may result in deviations from the nominal size of the air gap. Generally, a greater number of such components results in a greater risk that the size of the air gap will deviate from nominal. As is explained herein, certain image capture devices may include a generally large number of components connecting the lens(es) of the ISLA to the lens(es) of the external component. For example, omnidirectional image capture devices that include a pair of ISLAs may connect a second of the ISLAs to the external component of the image capture device via a first of the ISLAs, thereby increasing the number of components connecting the lens(es) of the second ISLA to the lens(es) of the external component, which may result in an increased risk that the size of the air gap therebetween will deviate from nominal. The present disclosure describes a shim system configured to adjust the size of the air gap toward nominal.

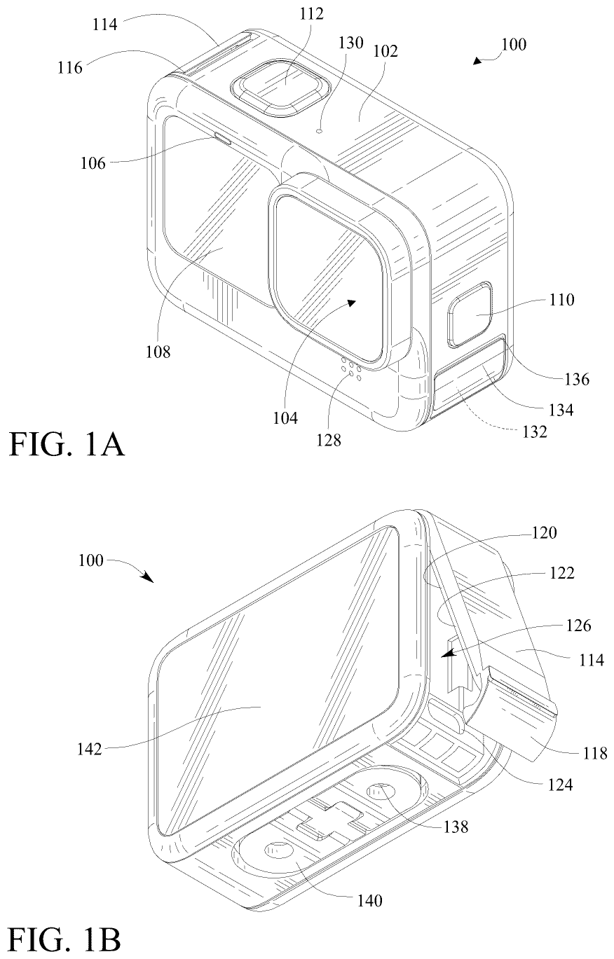

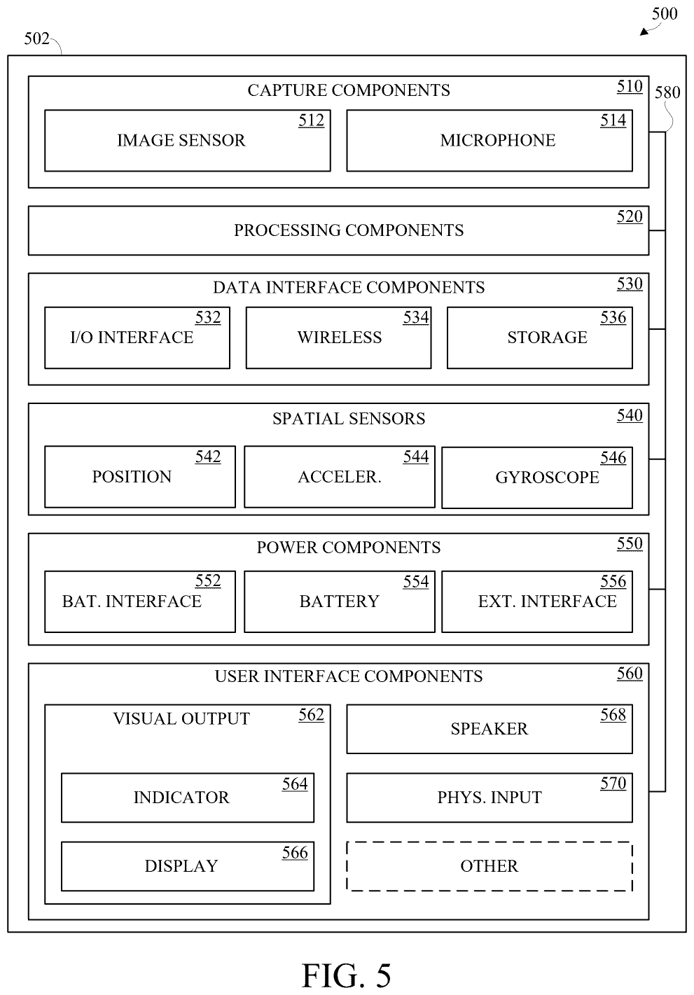

FIGS. 1A-1B are isometric views of an example of an image capture device 100. The image capture device 100 includes a body 102, an image sensor and lens assembly (ISLA) 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture device 100 includes internal electronics, such as imaging electronics, power electronics, and the like, internal to the body 102 for capturing images and performing other functions of the image capture device 100. An example showing internal electronics is shown in FIG. 5. The arrangement of the components of the image capture device 100 shown in FIGS. 1A-1B is an example, other arrangements of elements may be used, except as is described herein or as is otherwise clear from context.

The body 102 of the image capture device 100 may be made of a rigid material such as plastic, aluminum, steel, or fiberglass. Other materials may be used. The ISLA 104 is structured on a front surface of, and within, the body 102. The ISLA 104 includes a lens. The lens of the ISLA 104 receives light incident upon the lens of the ISLA 104 and directs the received light onto an image sensor of the ISLA 104 internal to the body 102. The image capture device 100 may capture one or more images, such as a sequence of images, such as video. The image capture device 100 may store the captured images and video for subsequent display, playback, or transfer to an external device. Although one ISLA 104 is shown in FIG. 1A, the image capture device 100 may include multiple image capture devices, which may be structured on respective surfaces of the body 102.

As shown in FIG. 1A, the image capture device 100 includes the indicator 106 structured on the front surface of the body 102. The indicator 106 may output, or emit, visible light, such as to indicate a status of the image capture device 100. For example, the indicator 106 may be a light-emitting diode (LED). Although one indicator 106 is shown in FIG. 1A, the image capture device 100 may include multiple indictors structured on respective surfaces of the body 102.

As shown in FIG. 1A, the image capture device 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture device 100. In some implementations, the display 108 may be omitted or combined with another component of the image capture device 100.

As shown in FIG. 1A, the image capture device 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture device 100 may include multiple mode, or configuration, buttons structured on respective surfaces of the body 102. In some implementations, the mode button 110 may be omitted or combined with another component of the image capture device 100. For example, the display 108 may be an interactive, such as touchscreen, display, and the mode button 110 may be physically omitted and functionally combined with the display 108.

As shown in FIG. 1A, the image capture device 100 includes the shutter button 112 structured on a top surface of the body 102. The shutter button 112 may be another type of input device, such as a switch, a toggle, a slider, or a dial. The image capture device 100 may include multiple shutter buttons structured on respective surfaces of the body 102. In some implementations, the shutter button 112 may be omitted or combined with another component of the image capture device 100.

The mode button 110, the shutter button 112, or both, obtain input data, such as user input data in accordance with user interaction with the image capture device 100. For example, the mode button 110, the shutter button 112, or both, may be used to turn the image capture device 100 on and off, scroll through modes and settings, and select modes and change settings.

As shown in FIG. 1B, the image capture device 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture device 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture device 100 includes the battery receptacle 126 structured to form a portion of an interior surface of the body 102. The battery receptacle 126 includes operative connections for power transfer between the battery and the image capture device 100. In some implementations, the battery receptacle 126 may be omitted. The image capture device 100 may include multiple battery receptacles.

As shown in FIG. 1A, the image capture device 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture device 100. The image capture device 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture device 100.

As shown in FIG. 1B, the image capture device 100 includes the speaker 138 structured on a bottom surface of the body 102. The speaker 138 outputs or presents audio, such as by playing back recorded audio or emitting sounds associated with notifications. The image capture device 100 may include multiple speakers structured on respective surfaces of the body 102.

As shown in FIG. 1B, the image capture device 100 includes the interconnect mechanism 140 structured on a bottom surface of the body 102. The interconnect mechanism 140 removably connects the image capture device 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture device 100 may include multiple interconnect mechanisms structured on, or forming a portion of, respective surfaces of the body 102. In some implementations, the interconnect mechanism 140 may be omitted.

As shown in FIG. 1B, the image capture device 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture device 100. The image capture device 100 may include multiple displays structured on respective surfaces of the body 102, such as the displays 108, 142 shown in FIGS. 1A-1B. In some implementations, the display 142 may be omitted or combined with another component of the image capture device 100.

The image capture device 100 may include features or components other than those described herein, such as other buttons or interface features. In some implementations, interchangeable lenses, cold shoes, and hot shoes, or a combination thereof, may be coupled to or combined with the image capture device 100. For example, the image capture device 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture device 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture device 100 via the computing communication link, or receive user input and communicate information with the image capture device 100 via the computing communication link. The external user interface device may implement or execute one or more applications to manage or control the image capture device 100. For example, the external user interface device may include an application for controlling camera configuration, video acquisition, video display, or any other configurable or controllable aspect of the image capture device 100. In some implementations, the external user interface device may generate and share, such as via a cloud-based or social media service, one or more images or video clips. In some implementations, the external user interface device may display unprocessed or minimally processed images or video captured by the image capture device 100 contemporaneously with capturing the images or video by the image capture device 100, such as for shot framing or live preview.

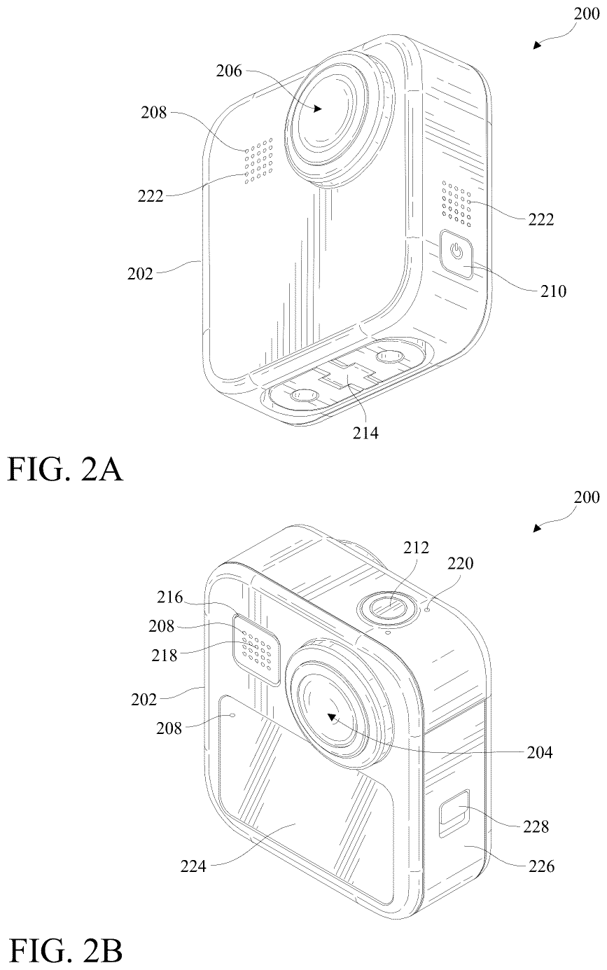

FIGS. 2A-2B illustrate another example of an image capture device 200. The image capture device 200 is similar to the image capture device 100 shown in FIGS. 1A-1B. The image capture device 200 includes a body 202, a first ISLA 204, a second ISLA 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture device 200 shown in FIGS. 2A-2B is an example, other arrangements of elements may be used.

The body 202 of the image capture device 200 may be similar to the body 102 shown in FIGS. 1A-1B. The first ISLA 204 is structured on a front surface of the body 202. The first ISLA 204 includes a first lens. The first ISLA 204 may be similar to the ISLA 104 shown in FIG. 1A. As shown in FIG. 2A, the image capture device 200 includes the ISLA 206 structured on a rear surface of the body 202. The second ISLA 206 includes a second lens. The second ISLA 206 may be similar to the ISLA 104 shown in FIG. 1A. The ISLAs 204, 206 are disposed on opposing surfaces of the body 202, for example, in a back-to-back configuration, Janus configuration, or offset Janus configuration. The image capture device 200 may include other image capture devices structured on respective surfaces of the body 202.

As shown in FIG. 2B, the image capture device 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first ISLA 204 and another one of the indicators 208 may indicate a status of the second ISLA 206. Although two indicators 208 are shown in FIGS. 2A-2B, the image capture device 200 may include other indictors structured on respective surfaces of the body 202.

As shown in FIGS. 2A-2B, the image capture device 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture device 200 includes internal electronics (not expressly shown), such as imaging electronics, power electronics, and the like, internal to the body 202 for capturing images and performing other functions of the image capture device 200. An example showing internal electronics is shown in FIG. 5.

As shown in FIGS. 2A-2B, the image capture device 200 includes the interconnect mechanism 214 structured on a bottom surface of the body 202. The interconnect mechanism 214 may be similar to the interconnect mechanism 140 shown in FIG. 1B.

As shown in FIG. 2B, the image capture device 200 includes the drainage channel 216 for draining liquid from audio components of the image capture device 200.

As shown in FIGS. 2A-2B, the image capture device 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture device 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture device 200 may include multiple displays structured on respective surfaces of the body 202. In some implementations, the display 224 may be omitted or combined with another component of the image capture device 200.

As shown in FIG. 2B, the image capture device 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture device 200 may include features or components other than those described herein, some features or components described herein may be omitted, or some features or components described herein may be combined. For example, the image capture device 200 may include additional interfaces or different interface features, interchangeable lenses, cold shoes, or hot shoes.

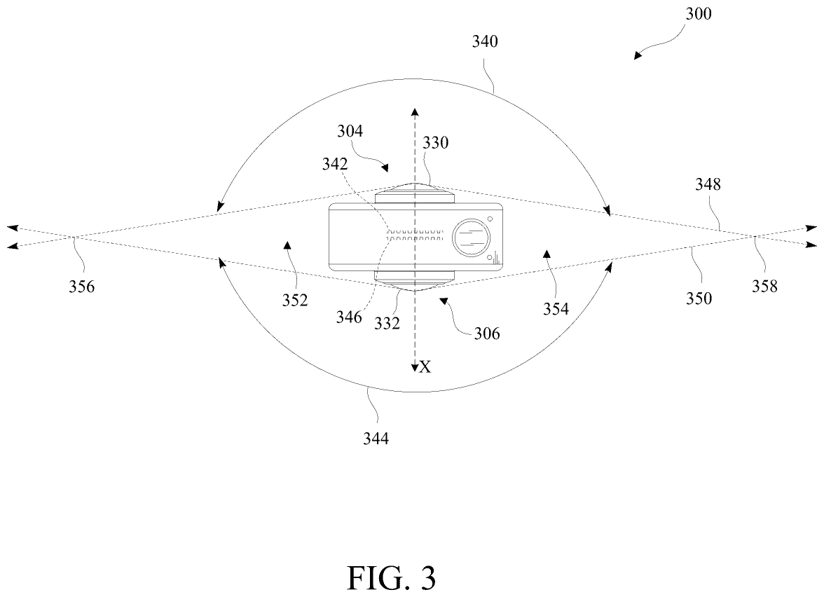

FIG. 3 is a top view of an image capture device 300. The image capture device 300 is similar to the image capture device 200 of FIGS. 2A-2B and is configured to capture spherical images.

As shown in FIG. 3, a first ISLA 304 includes a first lens 330 and a second ISLA 306 includes a second lens 332. For example, the first ISLA 304 may capture a first image, such as a first hemispheric, or hyper-hemispherical, image, the second ISLA 306 may capture a second image, such as a second hemispheric, or hyper-hemispherical, image, and the image capture device 300 may generate a spherical image incorporating or combining the first image and the second image, which may be captured concurrently, or substantially concurrently.

The first ISLA 304 defines a first field-of-view 340 wherein the first lens 330 of the first ISLA 304 receives light. The first lens 330 directs the received light corresponding to the first field-of-view 340 onto a first image sensor 342 of the first ISLA 304. For example, the first ISLA 304 may include a first lens barrel (not expressly shown), extending from the first lens 330 to the first image sensor 342.

The second ISLA 306 defines a second field-of-view 344 wherein the second lens 332 receives light. The second lens 332 directs the received light corresponding to the second field-of-view 344 onto a second image sensor 346 of the second ISLA 306. For example, the second ISLA 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the ISLAs 304, 306 are arranged in a back-to-back (Janus) configuration such that the lenses 330, 332 face in opposite directions, and such that the image capture device 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture device 300, may be obscured from the lenses 330, 332 and the corresponding image sensors 342, 346, such that content corresponding to the uncaptured areas 352, 354 may be omitted from images captured by the image capture device 300. In some implementations, the ISLAs 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the ISLAs 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the ISLAs 304, 306, such as the locations of the overlap points 356, 358, may decrease the accuracy, efficiency, or both of generating a combined image. In some implementations, the image capture device 300 may maintain information indicating the location and orientation of the ISLAs 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture device 300 (not shown), or laterally offset and off-center from the central axis (not shown). Whether through use of offset or through use of compact ISLAs 304, 306, a reduction in distance between the lenses 330, 332 along the axis X may improve the overlap in the fields-of-view 340, 344, such as by reducing the uncaptured areas 352, 354.

Images or frames captured by the ISLAs 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

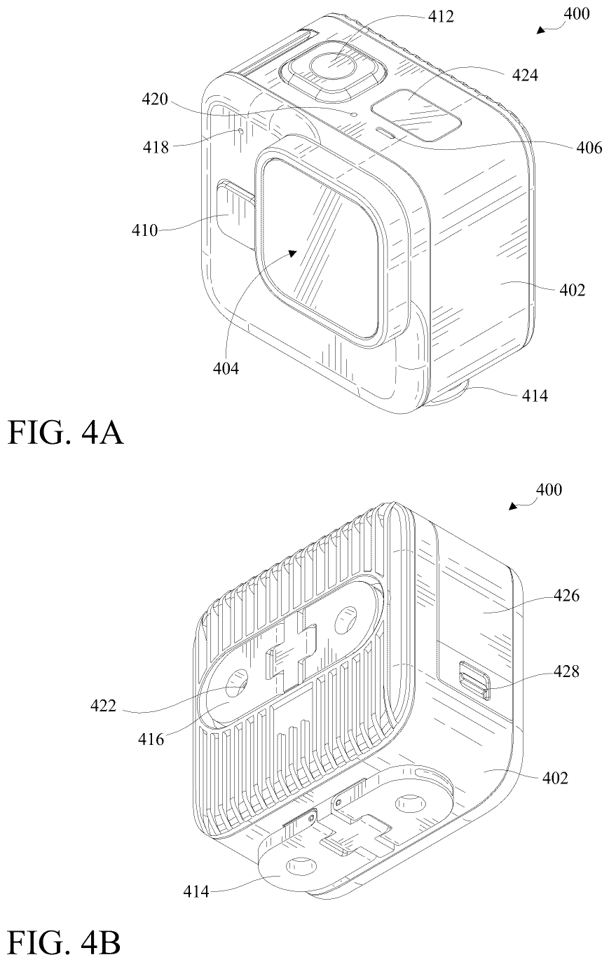

FIGS. 4A-4B illustrate another example of an image capture device 400. The image capture device 400 is similar to the image capture device 100 shown in FIGS. 1A-1B and to the image capture device 200 shown in FIGS. 2A-2B. The image capture device 400 includes a body 402, an ISLA 404, an indicator 406, a mode button 410, a shutter button 412, interconnect mechanisms 414, 416, audio components 418, 420, 422, a display 424, and a door 426 including a release mechanism 428. The arrangement of the components of the image capture device 400 shown in FIGS. 4A-4B is an example, other arrangements of elements may be used.

The body 402 of the image capture device 400 may be similar to the body 102 shown in FIGS. 1A-1B. The ISLA 404 is structured on a front surface of the body 402. The ISLA 404 includes a lens and may be similar to the ISLA 104 shown in FIG. 1A.

As shown in FIG. 4A, the image capture device 400 includes the indicator 406 on a top surface of the body 402. The indicator 406 may be similar to the indicator 106 shown in FIG. 1A. The indicator 406 may indicate a status of the ISLA 204. Although one indicator 406 is shown in FIGS. 4A, the image capture device 400 may include other indictors structured on respective surfaces of the body 402.

As shown in FIGS. 4A, the image capture device 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture device 400 includes internal electronics (not expressly shown), such as imaging electronics, power electronics, and the like, internal to the body 402 for capturing images and performing other functions of the image capture device 400. An example showing internal electronics is shown in FIG. 5.

As shown in FIGS. 4A-4B, the image capture device 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture device 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture device 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture device 400 may include multiple displays structured on respective surfaces of the body 402. In some implementations, the display 424 may be omitted or combined with another component of the image capture device 200.

As shown in FIG. 4B, the image capture device 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture device 400 may include features or components other than those described herein, some features or components described herein may be omitted, or some features or components described herein may be combined. For example, the image capture device 400 may include additional interfaces or different interface features, interchangeable lenses, cold shoes, or hot shoes.

FIG. 5 is a block diagram of electronic components in an image capture device 500. The image capture device 500 may be a single-lens image capture device, a multi-lens image capture device, or variations thereof, including an image capture device with multiple capabilities such as the use of interchangeable integrated sensor lens assemblies. Components, such as electronic components, of the image capture device 100 shown in FIGS. 1A-1B, the image capture device 200 shown in FIGS. 2A-2B, the image capture device 300 shown in FIG. 3, or the image capture device 400 shown in FIGS. 4A-4B, may be implemented as shown in FIG. 5.

The image capture device 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture device 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture device 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture device 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture device 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture device 500 and the memory card, such as for storing images, recorded audio, or both captured by the image capture device 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture device 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture device 500, which may include obtaining, such as by receiving, temporal data, such as via a GPS signal. The accelerometer 544, which may be a three-axis accelerometer, may measure linear motion, linear acceleration, or both of the image capture device 500. The gyroscope 546, which may be a three-axis gyroscope, may measure rotational motion, such as a rate of rotation, of the image capture device 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture device 500 for operating the image capture device 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture device 500. The battery interface 552 may be similar to the battery receptacle 126 shown in FIG. 1B. The external power interface 556 obtains or receives power from an external source, such as a wall plug or external battery, and distributes the power to the components of the image capture device 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture device 500, output, such as display or present, information to a user, or both receive input and output information, such as in accordance with user interaction with the image capture device 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture device 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture device 500. The physical input interface 570 may be, for example, a button, a toggle, a switch, a dial, or a slider.

As shown in FIG. 5, the user interface components 560 include a broken line border box labeled “other” to indicate that components of the image capture device 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

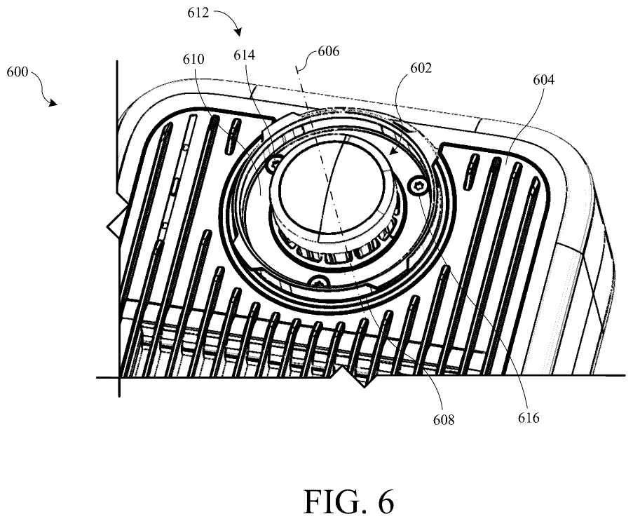

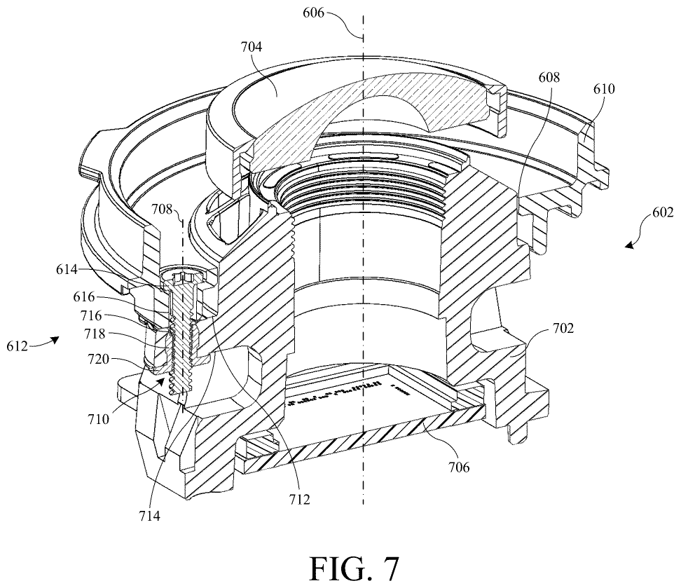

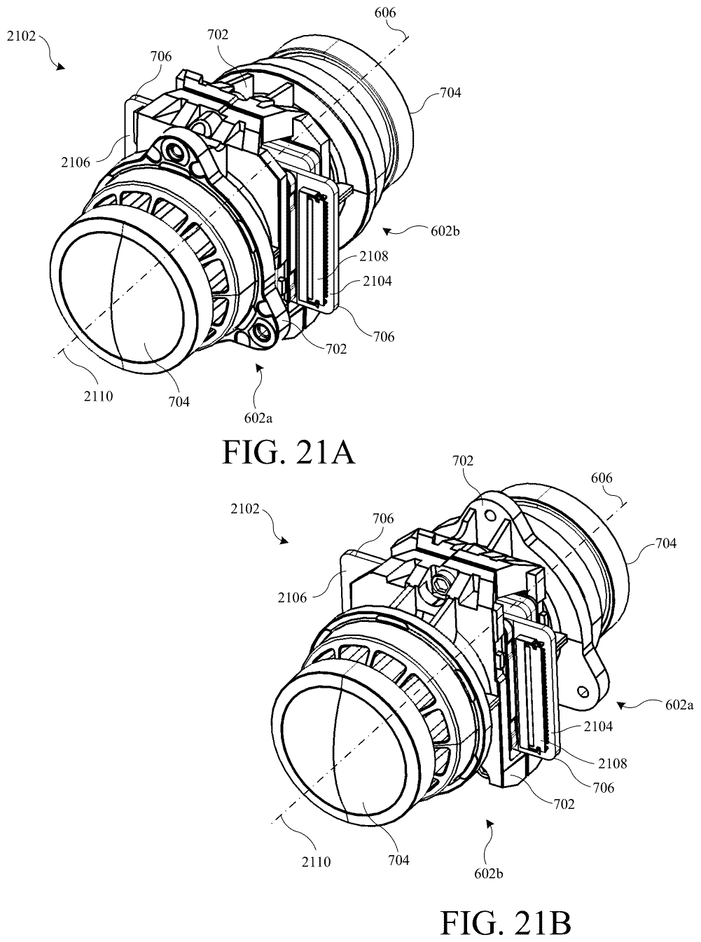

FIG. 6 is an isometric view of an image capture device 600. The image capture device 600 may be similar to the image capture devices 100, 200, 300, 400, 500 described above. The image capture device 600 includes an ISLA 602 and a body 604 that defines an interior and an exterior. The ISLA 602 may be similar to the ISLAs 104, 204, 206, 304, 306, 404 described above, and may be located either partially or entirely within the interior of the body 604. The ISLA 602 may define an optical axis 606 as described in further detail below with reference to FIG. 7. The body 604 may include an ISLA opening 608 that extends from the interior to the exterior of the body 604, and through which the ISLA 602 may extend. The body 604 may include a bayonet 610 that partially covers the ISLA opening 608 and is configured to receive accessories (e.g., lens accessories such as a removable lens cover). The bayonet 610 may be centrally positioned within the ISLA opening 608 to further define the ISLA opening 608. The image capture device 600 may be an omnidirectional image capture device including a first ISLA 602a and a second ISLA 602b as described in further detail with reference to FIGS. 21A-21B.

The image capture device 600 may include an attachment system 612 that is configured to secure (e.g., fix) the ISLA 602 relative to the body 604 centrally within the ISLA opening 608. The attachment system 612 may include one or more fasteners 614 (e.g., three of the fasteners 614) that extend from the exterior of the body 604, through respective body apertures 616 located on the body 604, and into respective inserts positioned on the ISLA 602 to connect the ISLA 602 to the body 604. The fasteners 614 may extend through the bayonet 610 of the body 604. Accordingly, the body apertures 616 may be located on the bayonet 610. Where the attachment system 612 includes multiple of the fasteners 614, the attachment system 612 may be configured such that the fasteners 614 are spaced around (e.g., spaced equidistantly around) the ISLA opening 608 and/or the optical axis 606. Accordingly, the body apertures 616 may also be spaced around the ISLA opening 608 and/or the optical axis 606. The fasteners 614 may be threaded fasteners.

FIG. 7 is a sectional view showing the attachment system 612 connecting the ISLA 602 to the bayonet 610 of the image capture device 600. The ISLA 602 includes a housing 702, a lens 704, and an image sensor 706. The housing 702 of the ISLA 602 supports the lens 704 and the image sensor 706 along the optical axis 606 such that light incident on the lens 704 may be directed along the optical axis 606 and onto the image sensor 706. In other words, the housing 702 may extend from the image sensor 706 to the lens 704 to define the optical axis 606.

The attachment system 612 shown in FIG. 7 includes one or more of the fasteners 614 that extend from the exterior of the body 604 along respective fastener axes 708 and into respective inserts 710. For example, one or more of the fasteners 614 may extend from the exterior of the body 604, through respective ones of the body apertures 616 located on the bayonet 610, into (e.g., through) the housing 702 of the ISLA 602, and into respective ones of the inserts 710 to connect the ISLA 602 to the bayonet 610 (and thus to the body 604). Although FIG. 7 only shows one of the fasteners 614 extending into one of the inserts 710, other of the fasteners 614 (e.g., two other of the fasteners 614) (not shown) may also extend in a similar fashion from the exterior of the body 604, through the bayonet 610, into (e.g., through) the housing 702, and into respective other ones of the inserts 710 (e.g., two other of the inserts 710) (not shown). The fastener axes 708 may be generally parallel with the optical axis 606.

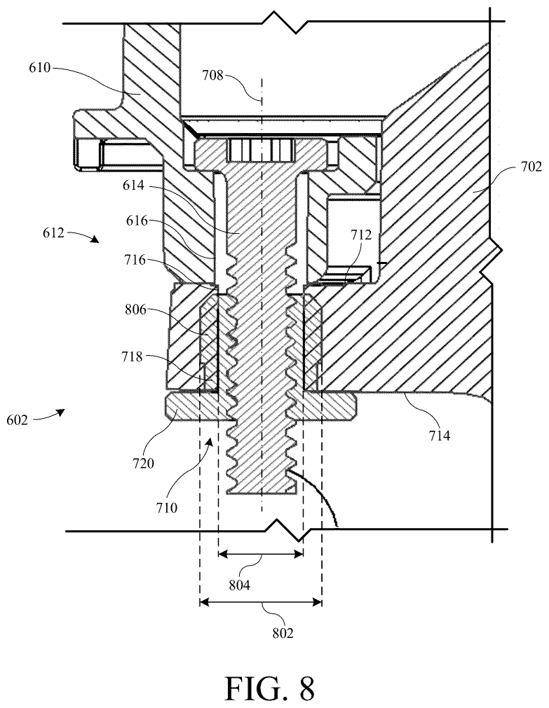

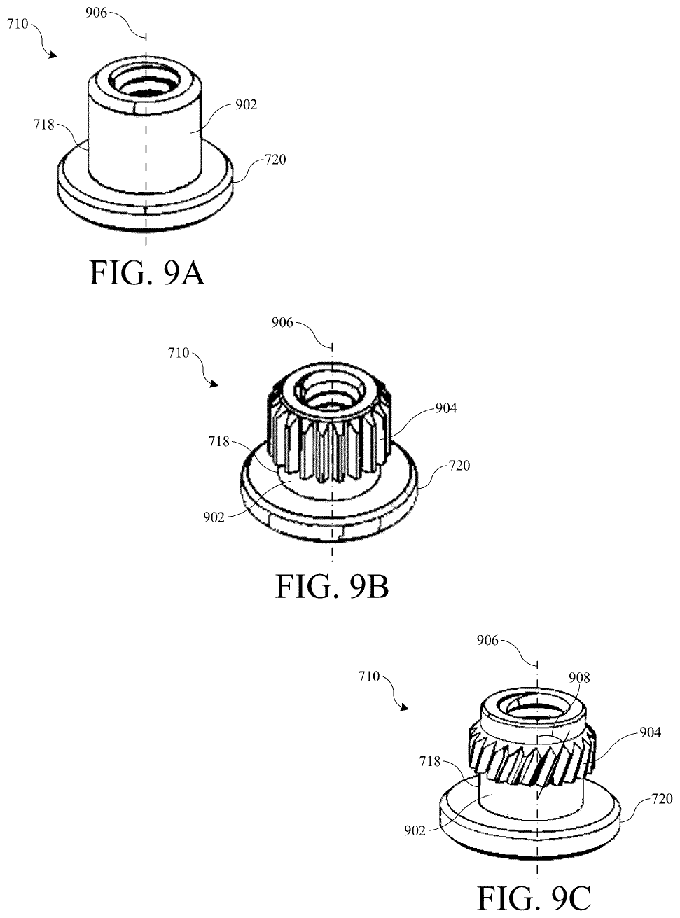

The housing 702 of the ISLA 602 may include a front surface 712 and a rear surface 714 that is opposite the front surface 712. The rear surface 714 may extend around (e.g., continuously around) the housing 702. The housing 702 may also include housing apertures 716 that extend from the front surface 712 to the rear surface 714. The housing apertures 716 may be spaced around the optical axis 606 of the ISLA 602 such that the housing apertures 716 are axially aligned with the body apertures 616. The inserts 710 may extend partially or entirely through respective ones of the housing apertures 716 to form respective connections with the housing 702. In other words, the housing apertures 716 may be configured to receive respective ones of the inserts 710 to form respective connections with the housing 702. The inserts 710 may be pressed fit into the housing apertures 716 as will be explained in further detail below with respect to FIGS. 8-9.

The inserts 710 may include a body portion 718 and a flange portion 720. The body portion 718 may extend into respective ones of the housing apertures 716 while the flange portion 720 rests on the rear surface 714 of the housing 702. Accordingly, the inserts 710 may be inserted into the housing apertures 716 from the rear surface 714 of the housing 702 along the fastener axis 708. The body portion 718 of the inserts 710 may have a cylindrical shape, in which the housing apertures 716 may have a complementary cylindrical shape. The inserts 710 and the housing apertures 716 (or portions thereof) may have other geometries as is explained in further detail herein. Where the fasteners 614 are threaded fasteners, the inserts 710 may include corresponding internal threads that are configured to engage the threads of the fasteners 614.

As previously indicated, the housing 702 of the ISLA 602 may be made of or comprise materials that have certain properties to promote controlled light travel from the lens 704 to the image sensor 706. Such materials, however, may lack other properties that enable robust engagement with the fasteners 614. For example, the housing 702 of the ISLA 602 may be made of or comprise a material such as polymethyl methacrylate (PMMA), polycarbonate (PC), and/or acrylonitrile butadiene styrene (ABS) that may have generally high stiffness and reflectivity. Such a material, however, may also be brittle (e.g., may have relatively low toughness) resulting in the housing 702 being prone to failing (e.g., cracking) were the fasteners 614 directly engage the housing 702. Accordingly, the inserts 710 may be inserted into the housing apertures 716 such that the fasteners 614 directly engage the inserts 710 rather than directly engage the housing 702.

The inserts 710 may be made of or comprise one or more of a metal, a polymer, and/or a composite that has properties that enable a robust connection with the fasteners 614. For example, where the fasteners 614 are threaded fasteners, the inserts 710 may be made of or comprise one or more of steel, aluminum, brass, nylon, polytetrafluoroethylene (PTFE), polyvinyl chloride (PVC), and/or some other metal, polymer, or composite that has properties that enable a robust threaded engagement with threads of the fasteners 614. In other words, the housing 702 of the ISLA 602 may be comprised of a first material that has first properties and the inserts 710 may be comprised of a second material that has different properties (e.g., higher toughness and/or lower stiffness) than the first material.

Accordingly, use of the inserts 710 may enable the fasteners 614 to be inserted into (e.g., through) the housing 702 to form a connection therewith without direct engagement with the housing 702. By enabling the fasteners 614 to be inserted into the housing 702, easier to access insertion trajectories for the fasteners 614 may be enabled that may have otherwise increased the risk that the housing 702 would fail (e.g., crack). For example, the fastener 614 shown in FIG. 7 extends from the exterior of the body 604 along the fastener axis 708 that is generally parallel with the optical axis 606 and into the insert 710. Such a fastener insertion trajectory may be easier to access than alternative insertion trajectories (e.g., insertion trajectories from the interior of the body 604), as the space above the bayonet 610 is generally free from other components. During assembly of the ISLA 602 to the body 604, the inserts 710 may be pressed fit into the housing apertures 716 before positioning the ISLA 602 within the interior of the body 604 and installing the fasteners 614 to connect the ISLA 602 to the body 604.

FIG. 8 is a cross-sectional view of the attachment system 612 shown in FIG. 7. FIG. 8 shows one of the fasteners 614 extending through one of the body apertures 616 along the fastener axis 708 and into one of the inserts 710 to connect the ISLA 602 to the bayonet 610. In the implementation shown in FIG. 8, the insert 710 is pressed fit into one of the housing apertures 716 of the housing 702 to form a connection therewith. To enable the pressed fit engagement of the inserts 710 with the housing 702, an outer diameter 802 of the body portion 718 of the inserts 710 may be larger than a diameter 804 of the housing apertures 716 such that the body portion 718 of the inserts 710 forms a radial interference 806 with the housing 702 around the housing apertures 716. The amount of the radial interference 806 (and therefore the outer diameter 802 of the body portion 718 of the inserts 710 and the diameter 804 of the housing apertures 716) may depend on the materials that form or comprise the housing 702 and the inserts 710, as well as on the configuration (e.g., the geometry) of the housing apertures 716 and the inserts 710.

FIGS. 9A-9C illustrate the inserts 710 that may be configured to be pressed fit into the housing apertures 716. The inserts 710 may include features (e.g., ribs, knurling, etc.) on an outer surface 902 of the body portion 718 that are configured to engage the housing 702 of the ISLA 602 to secure the inserts 710 thereto. The insert 710 shown in FIG. 9A is substantially cylindrical and is free from features on the outer surface 902 such that the outer surface 902 is substantially smooth. The insert 710 shown in FIG. 9B includes ribs 904 that extend radially outward from the outer surface 902 of the body portion 718. The ribs 904 of the inserts 710 shown in FIG. 9B are spaced around a longitudinal axis 906 of the insert 710 and extend longitudinally along the outer surface 902 of the body portion 718 parallel with the longitudinal axis 906. The ribs 904 may extend longitudinally along an entirety of the body portion 718 or along only a portion of the body portion 718. The ribs 904 may be configured to engage the housing 702 around the housing apertures 716 (e.g., to form the radial interference 806) to inhibit the inserts 710 from disengaging from the housing 702 along the fastener axis 708 and to inhibit rotation of the inserts 710 (e.g., when threaded fasteners engage the inserts 710). The insert 710 shown in FIG. 9C is similar to the insert 710 shown in FIG. 9B except that the ribs 904 are angled relative to the longitudinal axis 906. The ribs 904 may have any angle 908 relative to the longitudinal axis 906. For example, the angle 908 may be about 10 degrees, 20 degrees, 45 degrees, or some other angle.

Referring back to FIG. 8, as previously indicated, the amount of the radial interference 806 between the body portion 718 and the housing 702 may depend on the configuration (e.g., the geometry) of the inserts 710. For example, where the inserts 710 do not include any features on the outer surface (see e.g., FIG. 9A), the amount of the radial interference 806 between the body portion 718 and the housing 702 may be between about 0.1 mm and 0.2 mm. Accordingly, the outer diameter 802 of the body portion 718 may be between about 0.2 mm and 0.4 mm larger than the diameter 804 of the housing apertures 716. As another example, where the inserts 710 include the ribs 904 that extend parallel with the longitudinal axis 906 of the inserts 710 (see e.g., FIG. 9B), the amount of the radial interference 806 between the body portion 718 and the housing 702 may be between about 0.08 mm and 0.28 mm. Accordingly, the outer diameter 802 of the body portion 718, measured from the apexes of opposite ones of the ribs 904, may be between about 0.16 mm and 0.56 mm larger than the diameter 804 of the housing apertures 716. As yet another example, where the inserts 710 include the ribs 904 that extend at the angle 908 relative to the longitudinal axis 906 of the inserts 710 (see e.g., FIG. 9C), the amount of the radial interference 806 between the body portion 718 and the housing 702 may be between about 0.1 mm and 0.3 mm. Accordingly, the outer diameter 802 of the body portion 718, measured from the apexes of opposite ones of the ribs 904, may be between about 0.2 mm and 0.6 mm larger than the diameter 804 of the housing apertures 716. Other amounts of the radial interference 806 may also be used to provide a pressed fit connection between the inserts 710 and the housing 702.

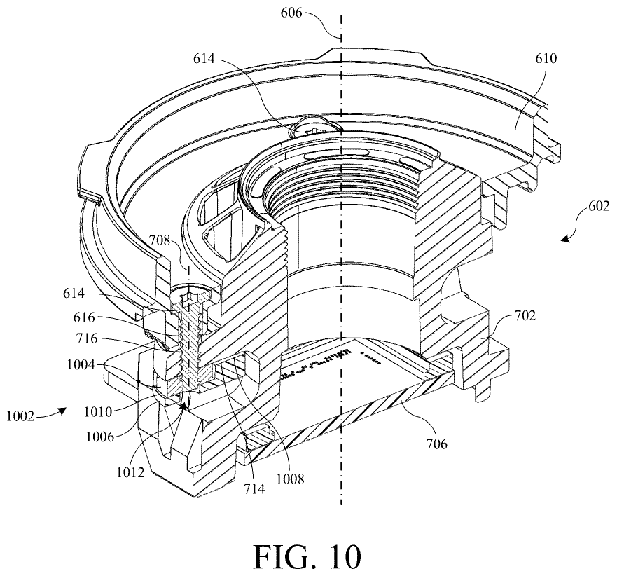

FIG. 10 is a sectional view showing an attachment system 1002 connecting the ISLA 602 to the bayonet 610 of the image capture device 600. The attachment system 1002 may be similar to the attachment system 612 described above with respect to FIGS. 7-9C and includes one or more of the fasteners 614 that extend from the exterior of the body 604 along respective ones of the fastener axes 708 and into respective inserts 1004. For example, one or more of the fasteners 614 may extend from the exterior of the body 604, through respective ones of the body apertures 616 located on the bayonet 610, through respective ones of the housing apertures 716 located on the housing 702, and into respective ones of the inserts 1004 to connect the ISLA 602 to the bayonet 610 (and thus to the body 604). Although FIG. 10 only shows one of the fasteners 614 extending into one of the inserts 1004, other of the fasteners 614 (e.g., two other of the fasteners 614) (one not shown) may also extend in a similar fashion from the exterior of the body 604, through the bayonet 610, through the housing 702, and into respective other ones of the inserts 1004 (e.g., two other ones of the inserts 1004) (not shown).

The inserts 1004 may be similar to the inserts 710 described with respect to FIGS. 7-9C except that the inserts 1004 do not extend into the housing apertures 716 of the housing 702 but are rather positionable on the rear surface 714 of the housing 702. Accordingly, to connect the ISLA 602 to the bayonet 610, the fasteners 614 may extend through the housing apertures 716 to engage respective ones of the inserts 1004 located on the rear surface 714 without threads of the fasteners 614 directly engaging the housing 702. Like the inserts 710, the inserts 1004 may include internal threads that are configured to engage threads of the fasteners 614. The inserts 1004 may have a hexagonal prism shape (e.g., may be hexagonal nuts) or may have some other shape. The inserts 1004 shown in FIG. 10 do not include the body portion 718 or features on the outer surface 902 thereof that engage the housing 702 to secure the inserts 1004 with respect to the housing 702. Accordingly, the attachment system 1402 shown in FIG. 10 may include anti-rotation devices 1006 that are configured to receive and inhibit rotation of respective ones of the inserts 1004. The anti-rotation devices 1006 may be separate from the housing 702 and positionable on (e.g., connectable to) the rear surface 714 of the housing 702.

The anti-rotation devices 1006 may include a connection surface 1008 that is configured to interface with the rear surface 714 of the housing 702 and a recessed portion 1010 that is configured to receive the inserts 1004. The connection surface 1008 of the anti-rotation devices 1006 may be bonded to the rear surface 714 of the housing 702 via an adhesive (e.g., a pressure sensitive adhesive, etc.). Once the anti-rotation devices 1006 have been connected to the rear surface 714 of the housing 702, the recessed portion 1010 may form a lateral opening through which a respective one of the inserts 1004 may be inserted into the recessed portion 1010 from the lateral direction relative to the fastener axis 708. Alternatively, the anti-rotation devices 1006 may be positioned over the inserts 1004 and connected to the rear surface 714 of the housing 702 after positioning the inserts 1004 on the rear surface 714. Once the inserts 1004 have been received by respective ones of the anti-rotation devices 1006, sides of the recessed portion 1010 may engage sides of the inserts 1004 to inhibit rotation of the inserts 1004. The anti-rotation devices 1006 may also include anti-rotation device apertures 1012 that are configured to provide clearance (e.g., to receive) the fasteners 614 where the fasteners 614 extend beyond the inserts 1004 along the fastener axis 708. Accordingly, the anti-rotation device apertures 1012 may be configured to be axially aligned with the body apertures 616 and the housing apertures 716 of the housing 702.

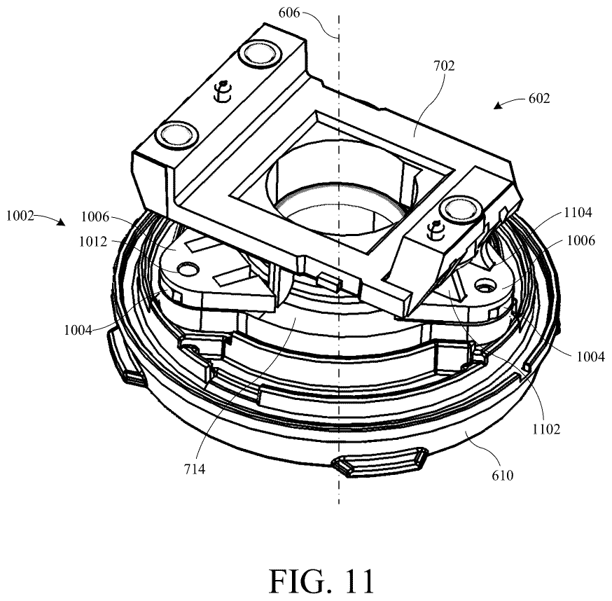

FIG. 11 is an isometric view of the ISLA 602 including the attachment system 1002 shown in FIG. 10. For clarity, the image sensor 706 is excluded. As shown, the anti-rotation devices 1006 may include features that interface with features of the housing 702 of the ISLA 602, and which may be used to locate the anti-rotation devices 1006 to the rear surface 714 of the housing 702 (e.g., to axially align the anti-rotation device apertures 1012 with the housing apertures 716). For example, where the housing 702 includes structural ribs 1102, the anti-rotation devices 1006 may include corresponding slots 1104 that are configured to receive the structural ribs 1102. During assembly of the ISLA 602 to the body 604, the inserts 1004 and the anti-rotation devices 1006 may be positioned on the rear surface 714 of the housing 702 before positioning the ISLA 602 within the interior of the body 604 and installing the fasteners 614 to connect the ISLA 602 to the body 604.

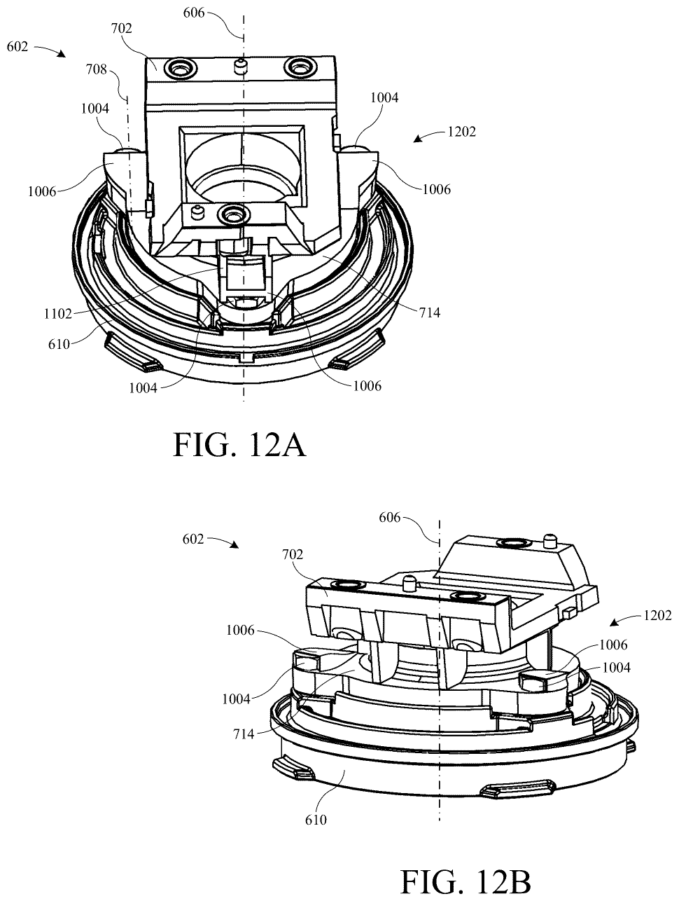

FIGS. 12A-12B are isometric views of the ISLA 602 that includes an attachment system 1202. For clarity, the image sensor 706 is excluded. The attachment system 1202 may be similar to the attachment system 1402 described above with respect to FIGS. 10-11 except that the anti-rotation devices 1006 are unitarily formed with the housing 702 rather than being separate from the housing 702. For example, the anti-rotation devices 1006 may be molded as portions of the housing 702. As shown in FIG. 12A, one of the anti-rotation devices 1006 may be formed with the structural ribs 1102 of the housing 702 on the rear surface 714 thereof to receive and inhibit rotation of one of the inserts 1004. The other two of the anti-rotation devices 1006 shown in FIGS. 12A-12B may also be formed on the rear surface 714 of the housing 702 to receive and inhibit rotation of respective other ones of the inserts 1004. The anti-rotation devices 1006 may include lateral openings that enable the inserts 1004 to be inserted therein from a lateral direction relative to the fastener axis 708. During assembly of the ISLA 602 to the body 604, the inserts 1004 may be positioned within the anti-rotation devices 1006 on the rear surface 714 of the housing 702 before positioning the ISLA 602 within the interior of the body 604 and installing the fasteners 614 to connect the ISLA 602 to the body 604.

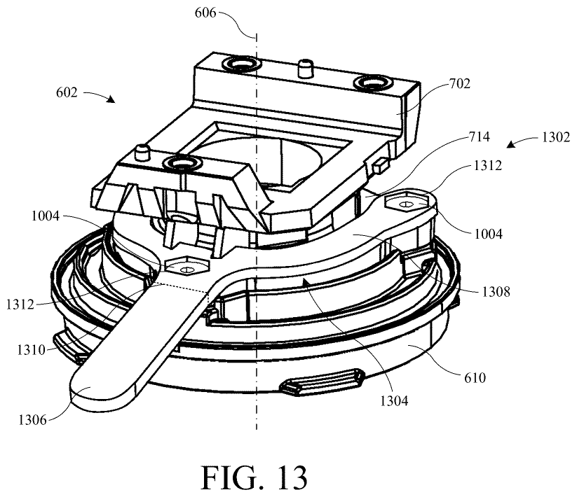

FIG. 13 is an isometric view of the ISLA 602 that includes an attachment system 1302. For clarity, the image sensor 706 is excluded. The attachment system 1302 may be similar to the attachment system 1002 described with respect to FIGS. 10-11 except that the anti-rotation devices 1006 are formed into an anti-rotation tool 1304 that is positionable on the rear surface 714 of the housing 702. The anti-rotation tool 1304 may include a handle 1306 and an anti-rotation member 1308. The handle 1306 may be severable from the anti-rotation member 1308 along one or more indents 1310 (e.g., perforations). The anti-rotation devices 1006 may be included on the anti-rotation member 1308 in the form of openings 1312 (e.g., three of the openings 1312) that are configured to receive and inhibit rotation of respective ones of the inserts 1004. The anti-rotation member 1308 may be generally U-shaped such as to extend around the housing 702 to access each of the inserts 1004. During assembly of the ISLA 602 to the body 604, the inserts 1004 and the anti-rotation tool 1304 may be positioned on the rear surface 714 of the housing 702 before installing the fasteners 614 to connect the ISLA 602 to the body 604. After connecting the ISLA 602 to the body 604, the handle 1306 may be severed from the anti-rotation member 1308 along the one or more indents 1310 to remove the handle 1306 from the interior of the body 604.

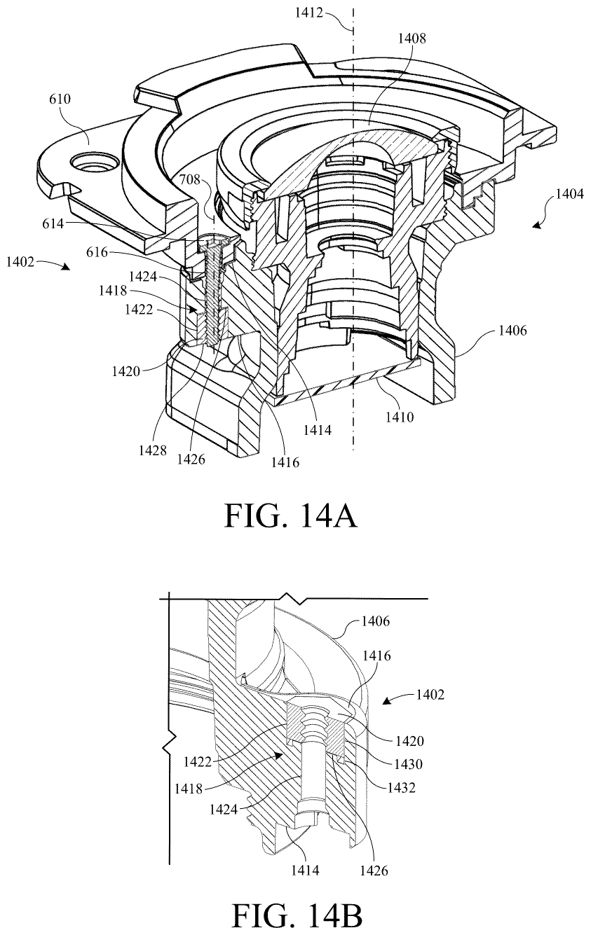

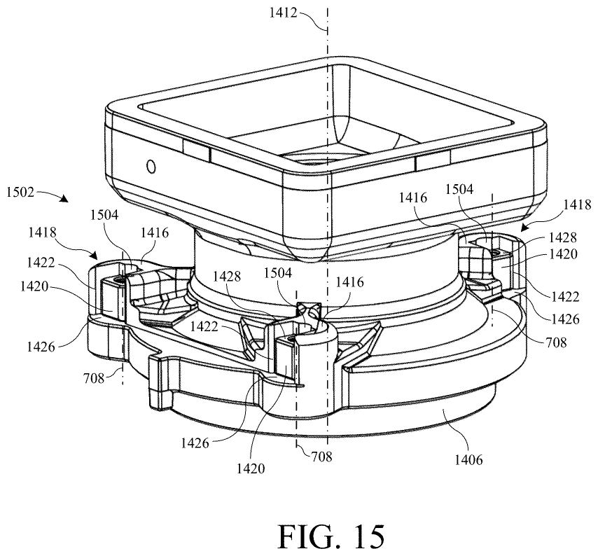

FIG. 14A is a sectional view showing an attachment system 1402 connecting an ISLA 1404 to the bayonet 610 of the image capture device 600. The ISLA 1404 may be similar to the ISLA 602 described above with respect to FIGS. 6-7. Accordingly, the ISLA 1404 may include a housing 1406 that is similar to the housing 702 and that is configured to support a lens 1408 and an image sensor 1410 along an optical axis 1412 similarly to as described above with respect to the ISLA 602. The housing 1406 may also include a front surface 1414, a rear surface 1416, and housing apertures 1418 that are each similar to those of the housing 702. However, as best shown in FIG. 15, in contrast to the rear surface 714 of the housing 702 which may extend around (e.g., continuously around) the housing 702, the rear surface 1416 may be one of multiple rear surfaces 1416 that may each surround respective ones of the housing apertures 1418.

The attachment system 1402 may be similar to the attachment system 612 described above with respect to FIGS. 7-9C and may include one or more of the fasteners 614 that extend from the exterior of the body 604 along respective ones of the fastener axes 708 and into respective inserts 1420. For example, one or more of the fasteners 614 may extend from the exterior of the body 604, through respective ones of the body apertures 616 located on the bayonet 610, into (e.g., through) respective ones of the housing apertures 1418 located on the housing 1406, and into respective ones of the inserts 1420 to connect the ISLA 1404 to the bayonet 610 (and thus to the body 604). Although FIG. 10A only shows one of the fasteners 614 extending into one of the inserts 1420, other of the fasteners 614 (e.g., two other of the fasteners 614) (not shown) may also extend in a similar fashion from the exterior of the body 604, through the bayonet 610, into (e.g., through) the housing 1406, and into respective other ones of the inserts 1420 (e.g., two other of the inserts 1420) (not shown).

The housing apertures 1418 of the housing 1406 may include a wide portion 1422 that is proximate the rear surfaces 1416 and a narrow portion 1424 that is proximate the front surface 1414, in which the wide portion 1422 is wider than (e.g., has a larger diameter than) the narrow portion 1424. An intermediate surface 1426 of the wide portion 1422 may extend between sides of the wide portion 1422 and sides of the narrow portion 1424. The inserts 1420 may be configured to be inserted along the fastener axis 708 from the rear surfaces 1416 into the wide portion 1422 of respective ones of the housing apertures 1418 such that the inserts 1420 extend partially or entirely therethrough. Like the inserts 710 described above with respect to FIGS. 7-9C, the inserts 1420 may include internal threads that are configured to engage threads of the fasteners 614. However, the inserts 1420 may differ from the inserts 710 in that the inserts 1420 may not include the flange portion 720. Accordingly, when inserted into the housing apertures 1418, the inserts 1420 may contact the intermediate surface 1426 of the wide portion 1422 while a rearward surface 1428 of the inserts 1420 may be substantially flush with the rear surfaces 1416 of the housing 1406. The inserts 1420 may have any suitable shape. For example, the inserts 1420 be substantially cylindrical and may be pressed fit into the housing apertures 1418 (e.g., the wide portion 1422 of the housing apertures 1418) similar to as described with respect to the inserts 710 shown in FIGS. 7-9C. The inserts 1420 may be free from features on an outer surface 1430 thereof such that the outer surface 1430 is substantially smooth. Alternatively, the inserts 1420 may include features (e.g., the ribs 904, knurling, etc.) on the outer surface 1430 that are configured to engage the housing 1406 of the ISLA 1404 to inhibit the inserts 1420 from disengaging from the housing 1406 along the fastener axis 708 and/or to inhibit rotation of the inserts 1420 (e.g., when threaded fasteners engage the inserts 1420).

FIG. 14B is a sectional view showing one of the inserts 1420 extending into one of the housing apertures 1418. As shown, the inserts 1420 may have a hexagonal prism shape, in which the wide portion 1422 of the housing apertures 1418 may have a complementary hexagonal prism shape. Accordingly, when the inserts 1420 are inserted into respective ones of the housing apertures 1418, flat sides of the inserts 1420 may engage flat sides of the wide portion 1422 of the housing apertures 1418 to inhibit rotation of the inserts 1420. Furthermore, the intermediate surface 1426 of the wide portion 1422 of each of the housing apertures 1418 may include a channel 1432 that is configured to receive an adhesive (e.g., glue, epoxy, etc.) to secure the inserts 1420 within respective ones of the housing apertures 1418. The channel 1432 may extend continuously around a periphery of the wide portion 1422 or may extend around only a portion of the periphery of the wide portion 1422.

FIG. 15 is an isometric view of the housing 1406 of the ISLA 1404 (see FIG. 14A) including an attachment system 1502. The attachment system 1502 may be similar to the attachment system 1402 described above with respect to FIGS. 14A-14B except that the inserts 1420 are configured to be inserted into respective ones of the housing apertures 1418 from a lateral direction with respect to the fastener axes 708 rather than along the fastener axes 708. Accordingly, as shown, the wide portion 1422 of the housing apertures 1418 open in a lateral direction relative to the fastener axis 708 for respective ones of the inserts 1420 to be inserted therethrough. The inserts 1420 may have a rectangular prism shape (e.g., a cube shape). Accordingly, the wide portion 1422 of the housing apertures 1418 may have a complementary rectangular prism shape (e.g., a complementary cube shape). When the inserts 1420 are inserted into respective ones of the housing apertures 1418, flat sides of the inserts 1420 may engage flat sides of the wide portion 1422 of the housing apertures 1418 to inhibit rotation of the inserts 1420 (e.g., when threaded fasteners engage the inserts 1420). Furthermore, the wide portion 1422 of each of the housing apertures 1418 may include a lip 1504 that extends in a lateral direction relative to the fastener axis 708 from respective ones of the rear surfaces 1416 of the housing 1406. The lip 1504 may extend over at least a portion of the rearward surface 1428 of respective ones of the inserts 1420 to inhibit the inserts 1420 from disengaging from the housing 1406 along the fastener axis 708.

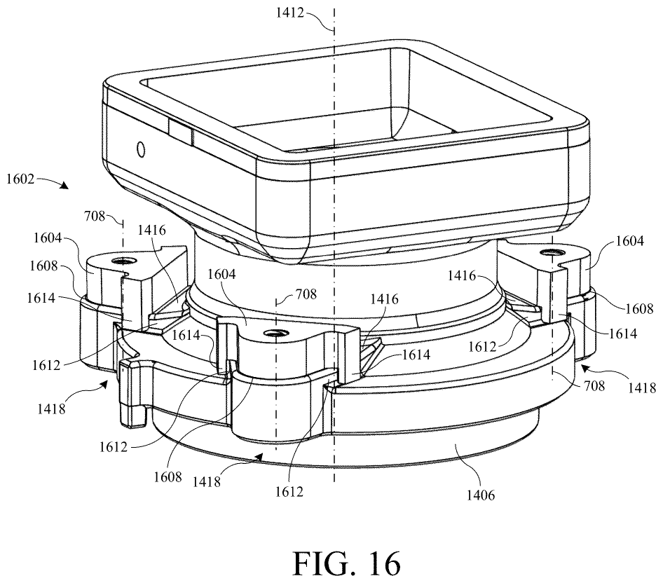

FIG. 16 is an isometric view of the housing 1406 of the ISLA 1404 (see FIG. 14A) that includes an attachment system 1602. The attachment system 1602 shown in FIG. 16 may be similar to the attachment system 1402 described above with respect to FIGS. 14A-14B and includes one or more of the fasteners 614 (not expressly shown) that extend from the exterior of the body 604 along respective ones of the fastener axes 708 and into respective inserts 1604. The inserts 1604 may be similar to the inserts 1420 described above with respect to FIGS. 14A-14B, except that the inserts 1604 do not extend into the housing apertures 1418 but are rather positionable on respective ones of the rear surfaces 1416 of the housing 1406. Accordingly, to connect the ISLA 1404 to the bayonet 610 (see FIG. 14A), the fasteners 614 may extend through the housing apertures 1418 to engage respective ones of the inserts 1604 located on respective ones of the rear surfaces 1416 without threads of the fasteners 614 directly engaging the housing 1406.

The inserts 1604 may include internal threads that are configured to engage threads of the fasteners 614. Furthermore, the inserts 1604 may each include a connection surface 1608 that is configured to interface with respective ones of the rear surfaces 1416 of the housing 1406. The connection surface 1608 of the inserts 1604 may be bonded to the rear surfaces 1416 of the housing 1406 via an adhesive (e.g., a pressure sensitive adhesive, etc.).

The inserts 1604 may also include features that interface with features of the housing 1406 of the ISLA 1404 to locate the inserts 1604 to the rear surfaces 1416 thereof and to inhibit rotation of the inserts 1604 (e.g., when threaded fasteners engage the inserts 1604). For example, where the housing 1406 includes one or more walls 1612 that are connected to the rear surfaces 1416 thereof, the inserts 1604 may include one or more corresponding locating tabs 1614 (e.g., two of the locating tabs 1614) that are configured to interface with the one or more walls 1612. The locating tabs 1614 may extend from opposite lateral sides of the inserts 1604 in a direction generally parallel with the walls 1612. During assembly of the ISLA 1404 to the body 604, the inserts 1604 may be positioned on the rear surface 1416 of the housing 1406 before positioning the ISLA 1404 within the interior of the body 604 and installing the fasteners 614 to connect the ISLA 1404 to the body 604.

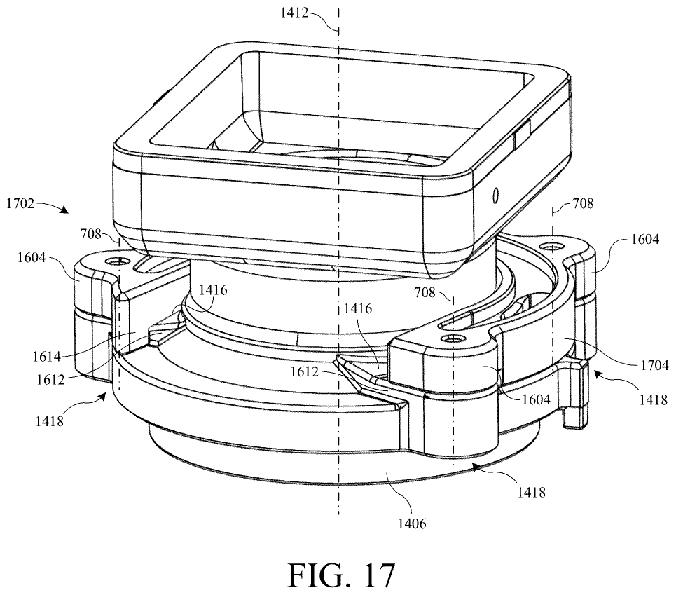

FIG. 17 is an isometric view of the housing 1406 of the ISLA 1404 (see FIG. 14A) that includes an attachment system 1702. The attachment system 1702 may be similar to the attachment system 1602 described above with respect to FIG. 16 except that the inserts 1604 are unitarily formed into a collar 1704. The collar 1704 may be generally U-shaped such as to extend around the housing 1406 to access each of the housing apertures 1418. The collar 1704 may also include one or more of the locating tabs 1614 that are configured to interface with corresponding ones of the walls 1612 of the housing 1406 to locate the collar 1704 to the rear surface 1416 of the housing 1406 and to inhibit rotation of the collar 1704 (e.g., when threaded fasteners engage the inserts 710). For example, as shown, one of the locating tabs 164 may be located at an end of the collar 1704. During assembly of the ISLA 1404 to the body 604, the collar 1704 may be positioned on the rear surfaces 1416 of the housing 1406 before installing the fasteners 614 to connect the ISLA 1404 to the body 604.

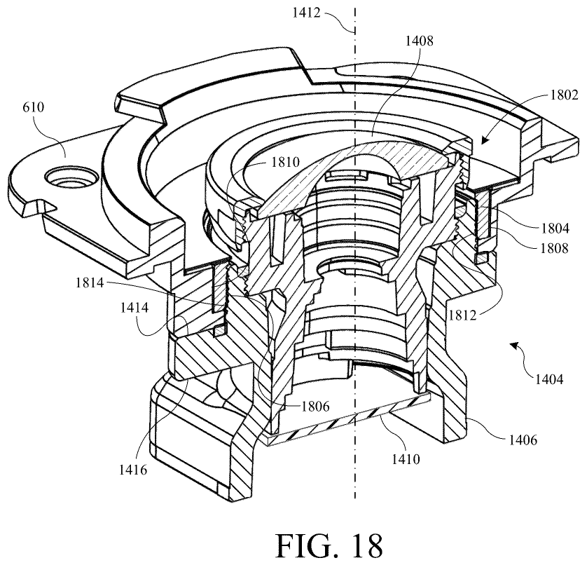

FIG. 18 is a sectional view showing an attachment system 1802 connecting the ISLA 1404 to the bayonet 610 of the image capture device 600. The attachment system 1802 may be similar to the attachment system 1402 described above with respect to FIGS. 14A-14B except that the attachment system 1802 excludes the fasteners 614 and the inserts 1420. Instead, the housing 1406 of the ISLA 1404 is connected to the bayonet 610 via a mounting ring 1804. Accordingly, the housing 1406 shown in FIG. 18 may exclude the housing apertures 1418. The mounting ring 1804 may be substantially cylindrical and include an inner surface 1806 and an outer surface 1808. The mounting ring 1804 may extend around an inward facing peripheral wall 1810 of the bayonet 610 such that the outer surface 1808 of the mounting ring 1804 interfaces with the peripheral wall 1810. The inner surface 1806 of the mounting ring 1804 may include inner threads 1812 that extend radially inward and that are configured to engage corresponding outer threads 1814 of the housing 1406 that extend radially outward from an outward surface 1816 of the housing 1406. Accordingly, to connect the housing 1406 of the ISLA 1404 to the bayonet 610, the outer surface 1808 of the mounting ring 1804 may be connected to the peripheral wall 1810 of the bayonet 610 (e.g., via adhesives or any other suitable means). The mounting ring 1804 and the bayonet 610 may then be screwed onto the housing 1406 of the ISLA 1404 such that the inner threads 1812 of the mounting ring 1804 engage the outer threads 1814 of the housing 1406.

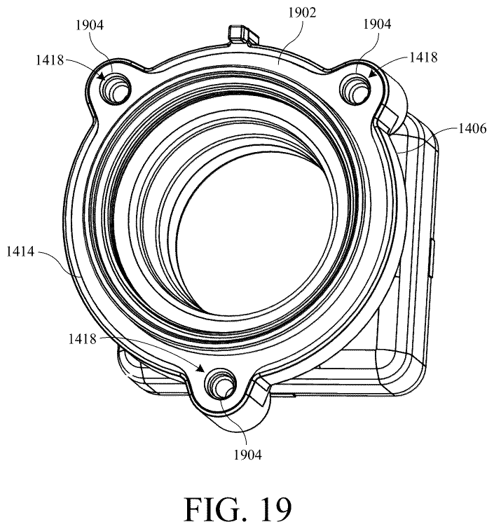

FIG. 19 is an isometric view of the housing 1406 of the ISLA 1404 (described previously with respect to FIG. 14A) including a seal 1902. It may be desired that the exterior of the body 604 of the image capture device 600 be sealed from the interior thereof. For example, it may be desired that dust, water, or the like from the exterior of the body 604 be inhibited from accessing portions of the ISLA 1404 (e.g., the image sensor 1410) that are located within the interior of the body 604. Accordingly, the ISLA 1404 may include the seal 1902 that extends along (e.g., continuously along) the front surface 1414 of the housing 1406. Upon installation of the fasteners 614 to connect the ISLA 1404 to the body 604, the seal 1902 may be compressed between the front surface 1414 and the body 604 (e.g., the bayonet 610) to form a sealing engagement therebetween. To enable the fasteners 614 to extend through the housing apertures 1418, the seal 1902 may include seal apertures 1904 that correspond to one or more of the housing apertures 1418 (e.g., three of the seal apertures 1904 corresponding to three of the housing apertures 1418) that are configured for respective ones of the fasteners 614 to extend therethrough. Accordingly, the seal apertures 1904 may be axially aligned with the body apertures 616 and the housing apertures 1418. Furthermore, by extending around the housing apertures 1418, the seal 1902 may also enable sealing of the image capture device 600 around each of the fasteners 614.

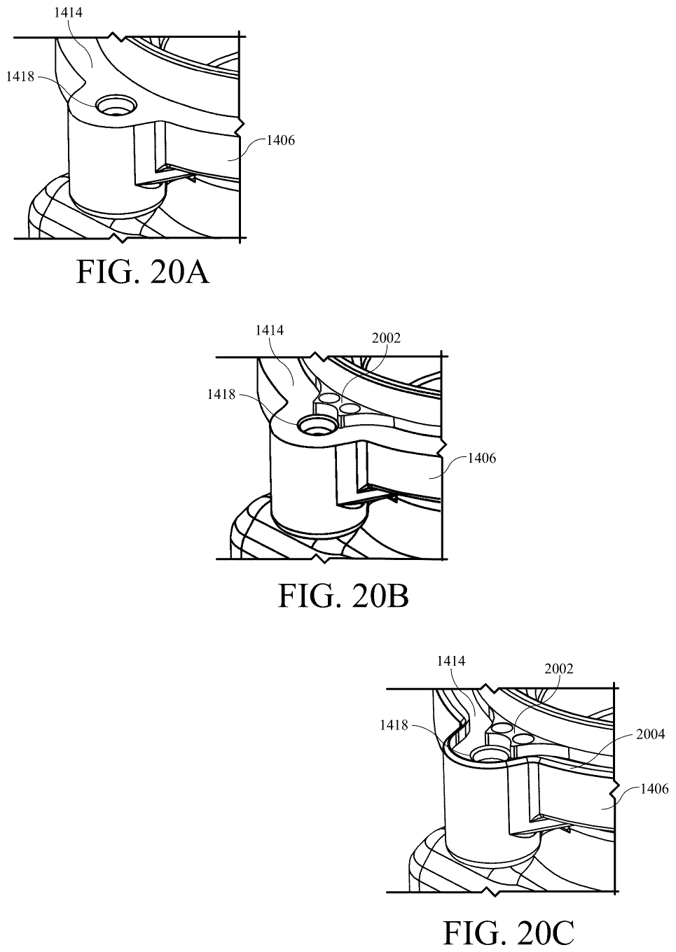

FIGS. 20A-20C show the front surface 1414 of the housing 1406 that may include various features for locating the seal 1902 to the front surface 1414 and to control deformation of the seal 1902 upon compression thereof. FIG. 20A shows the front surface 1414 of the housing 1406 in which the housing 1406 is generally free from features on the front surface 1414 such that the front surface 1414 is substantially smooth. Accordingly, the seal 1902 may be free to deform radially outward upon compression thereof. FIG. 20B shows the front surface 1414 of the housing 1406 in which the front surface 1414 includes routing members 2002 located radially inward from the housing apertures 1418. The routing members 2002 may route the seal 1902 radially outward around the housing apertures 1418. The routing members 2002 may also inhibit the seal 1902 from deforming radially inward upon compression thereof, while allowing the seal 1902 to deform radially outward. Where the front surface 1414 includes the routing members 2002, the seal 1902 may exclude the seal apertures 1904. FIG. 20C shows the front surface 1414 of the housing 1406 in which the front surface 1414 includes the routing members 2002 as well as a seal wall 2004 that extends around an outer periphery of the front surface 1414. The seal wall 2004 may assist in locating the seal 1902 to the front surface 1414 and may inhibit the seal 1902 from deforming radially outward upon compression thereof.

FIGS. 21A-21B are isometric views of an ISLA assembly 2102 for an omnidirectional image capture device, such as the image capture device 600, that includes the first ISLA 602a and the second ISLA 602b. The first ISLA 602a may be the ISLA 602 (described above with respect to FIG. 7) and the second ISLA 602b may be similar to the ISLA 602. Accordingly, each of the first ISLA 602a and the second ISLA 602b may include the housing 702, the lens 704, and the image sensor 706. The image sensor 706 of each of the first ISLA 602a and the second ISLA 602b may be substantially flat, including a first side 2104 that is opposite a second side 2106. The first side 2104 may be oriented toward the lens 704. The image sensor 706 of each of the first ISLA 602a and the second ISLA 602b may also include a connector 2108 on the first side 2104 for connecting a cable (e.g., a ribbon cable) thereto to transmit electrical information (e.g., image sensor data). As shown, the first ISLA 602a and the second ISLA 602b may face opposite (e.g., front and rear) directions and may be positioned along a common longitudinal axis 2110. Accordingly, the image sensor 706 of the first ISLA 602a and the image sensor 706 of the second ISLA 602b may be positioned in close proximity (e.g., adjacent) to one another along the common longitudinal axis 2110. The common longitudinal axis 2110 may align with the optical axis 606 of the first ISLA 602a and/or the second ISLA 602b.

As explained previously, positioning electronic components, such as the image sensor 706 of each of the first ISLA 602a and the second ISLA 602b, in close proximity to one another may result in electromagnetic interference (EMI) with the electronic components. For example, the image sensor 706 of the first ISLA 602a may include electrical components that emit electromagnetic radiation of a certain frequency that may interfere with electrical components (e.g., sensors, copper traces, antennas, etc.) of the image sensor 706 of the second ISLA 602b. EMI may cause noise in electrical data (e.g., may cause noise in signals) transmitted by the affected electronic components and thereby interfere with their intended operation. For example, EMI with the image sensor 706 of the first ISLA 602a and/or the image sensor 706 of the second ISLA 602b may result in noise in the signal transmitted by the image sensor 706 that is affected. Such noise may be more apparent in low light applications where the signal transmitted by the image sensor 706 is amplified to be better perceived by a human eye.

EMI may be more severe where, as shown in FIGS. 21A-21B, the image sensor 706 of each of the first ISLA 602a and the second ISLA 602b face each other such that the electrical components of each are in close proximity. Furthermore, other electronic components of the image capture device 600, such as the microphone 514, the processing components 520, the spatial sensors 540, the power components 550, and/or the user interface components 560, may also emit or receive electromagnetic radiation that can result in EMI with the other electronic components, the image sensor 706 of the first ISLA 602a, and/or the image sensor 706 of the second ISLA 602b. Therefore, it may be desired to inhibit (e.g., block) electromagnetic radiation of certain frequencies from traveling between the image sensor 706 of the first ISLA 602a, the image sensor 706 of the second ISLA 602b, and/or other electronic components of the image capture device 600.

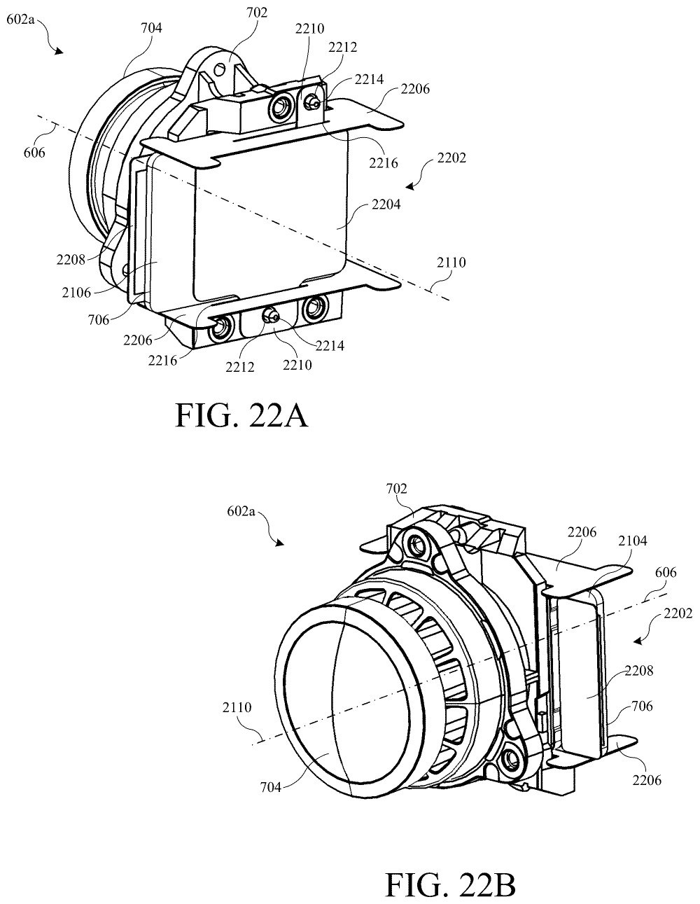

FIGS. 22A-22B are isometric views of the first ISLA 602a including a shielding system 2202 that is configured to absorb electromagnetic radiation of certain frequencies (e.g., frequencies between about 30 MHz and 10 GHz). The shielding system 2202 may comprise a horizontal shield 2204, one or more perpendicular shields 2206 (e.g., two of the perpendicular shields 2206), and one or more connector shields 2208 (e.g., two of the connector shields 2208). The horizontal shield 2204, the perpendicular shields 2206, and the connector shields 2208 may each be substantially planar and comprise a material that is configured to absorb a certain frequency range of electromagnetic radiation. For example, the horizontal shield 2204, the perpendicular shields 2206, and the connector shields 2208 may each comprise metal (e.g., foil) and/or electrically conductive (e.g., electrically semiconductive) polymers that are configured to absorb a certain frequency range of electromagnetic radiation. The shielding system 2202 may absorb electromagnetic radiation by converting the electromagnetic radiation into heat or by some other means.

The horizontal shield 2204 may be positioned parallel with and between the image sensor 706 of the first ISLA 602a and the image sensor 706 of the second ISLA 602b (see FIGS. 21A-21B) such that the horizontal shield 2204 is located on the second side 2106 of the image sensor 706 of each of the first ISLA 602a and the second ISLA 602b. Accordingly, the horizontal shield 2204 may be configured to inhibit (e.g., block) electromagnetic radiation of a certain frequency from traveling between the image sensor 706 of the first ISLA 602a and the image sensor 706 of the second ISLA 602b. To support and locate the horizontal shield 2204 to the housing 702, the horizontal shield 2204 may include one or more tabs 2210 (e.g., two of the tabs 2210) that each include a locating aperture 2212 that is configured to engage (e.g., receive) locating members 2214 of the housing 702 of the first ISLA 602a. The locating members 2214 of the housing 702 may extend from the housing 702 in a direction generally parallel with the common longitudinal axis 2110. In addition to supporting and locating the horizontal shield 2204 to the housing 702 of the first ISLA 602a, the locating members 2214 of the housing 702 may also be configured to engage corresponding locating holes (not shown) of the housing 702 of the second ISLA 602b to locate the first ISLA 602a to the second ISLA 602b.

The perpendicular shields 2206 may be positioned on opposite lateral sides of the image sensor 706 of the first ISLA 602a and the image sensor 706 of the second ISLA 602b (see FIGS. 21A-21B) such that the perpendicular shields 2206 are perpendicular to at least one of the image sensor 706 of the first ISLA 602a or the image sensor 706 of the second ISLA 602b. Accordingly, the perpendicular shields 2206 may be configured to inhibit (e.g., block) a certain frequency range of electromagnetic radiation from traveling from the other electronic components of the image capture device 600 to the image sensor 706 of the first ISLA 602a and/or the image sensor 706 of the second ISLA 602b. Furthermore, the perpendicular shields 2206 may be configured to inhibit (e.g., block) electromagnetic radiation from traveling from the image sensor 706 of the first ISLA 602a and/or the image sensor 706 of the second ISLA 602b to other electronic components of the image capture device 600. The perpendicular shields 2206 may each include a slit 2216 that extends therethrough and is configured to receive the tabs 2210 of the horizontal shield 2204, thereby connecting the perpendicular shields 2206 to the horizontal shield 2204 and to the first ISLA 602a. The slit 2216 may be substantially centered on each of the perpendicular shields 2206 such as to bisect a portion of each of the perpendicular shields 2206.

The connector shields 2208 may each be positioned over respective ones of the connector 2108 of the image sensor 706 of the first ISLA 602a and the connector 2108 of the image sensor 706 of the second ISLA 602b (see FIGS. 21A-21B). Accordingly, the connector shields 2208 may be configured to inhibit (e.g., block) a certain frequency range of electromagnetic radiation from traveling from the other electronic components of the image capture device 600 to the connector 2108 of the image sensor 706 of the first ISLA 602a and/or the connector 2108 of the image sensor 706 of the second ISLA 602b. By inhibiting electromagnetic radiation from traveling to the connector 2108, EMI with signals traveling through the connector 2108 and a corresponding cable (not shown) may be reduced or prevented. The connector shields 2208 may be connected to the first side 2104 of the image sensor 706 of the first ISLA 602a and to the first side 2104 of the image sensor 706 of the second ISLA 602b (see FIGS. 21A-21B) via an adhesive (e.g., a pressure sensitive adhesive) or by any other suitable means. By inhibiting electromagnetic radiation from traveling between the image sensor 706 of the first ISLA 602a, the image sensor 706 of the second ISLA 602b, and other components of the image capture device 600, the shielding system 2202 may reduce or prevent EMI that would otherwise cause noise in the related signals thereof.

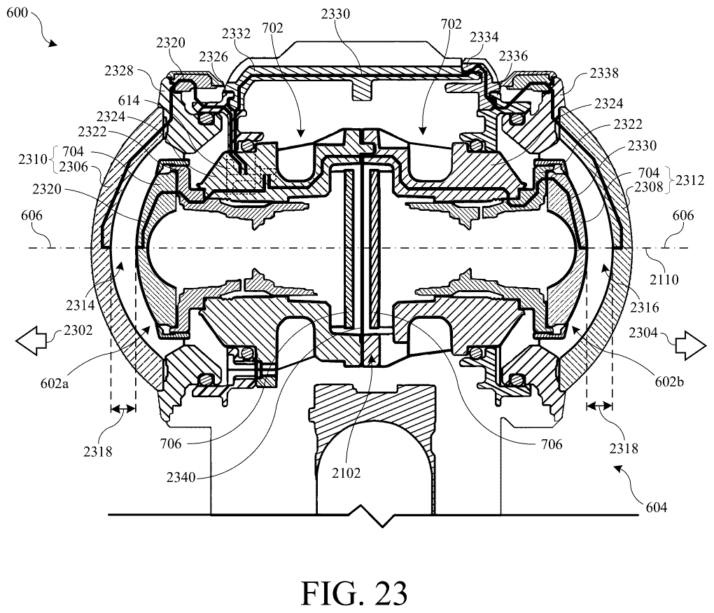

FIG. 23 is a cross sectional view of the image capture device 600. In the implementation shown in FIG. 23, the image capture device 600 is an omnidirectional image capture device that includes the ISLA assembly 2102 as described in FIGS. 21A-21B. The first ISLA 602a and the second ISLA 602b of the ISLA assembly 2102 may each include the housing 702, the lens 704, and the image sensor 706. The housing 702 of each of the first ISLA 602a and the second ISLA 602b supports the lens 704 and the image sensor 706 along the optical axis 606 thereof. The first ISLA 602a and the second ISLA 602b may be located partially or entirely within the interior of the body 604 of the image capture device 600. Furthermore, the first ISLA 602a and the second ISLA 602b may face opposite directions such that the first ISLA 602a faces a front direction 2302 and the second ISLA 602b faces a rear direction 2304. The optical axis 606 of each of the first ISLA 602a and the second ISLA 602b may be axially aligned with each other, and the optical axis 606 of one or both of the first ISLA 602a and the second ISLA 602b may be aligned with the common longitudinal axis 2110 of the ISLA assembly 2102.

The body 604 of the image capture device 600 may include a front body lens 2306 and a rear body lens 2308 that are configured to be in optical communication with the lens 704 of the first ISLA 602a and the second ISLA 602b, respectively. Accordingly, the lens 704 of the first ISLA 602a may be positioned adjacent to the front body lens 2306 and the lens 704 of the second ISLA 602b may be positioned adjacent to the rear body lens 2308. The front body lens 2306 and the lens 704 of the first ISLA 602a may be positioned along the optical axis 606 of the first ISLA 602a to form a first optical system 2310 in which light incident on the front body lens 2306 is directed along the optical axis 606 to the image sensor 706 of the first ISLA 602a. Similarly, the rear body lens 2308 and the lens 704 of the second ISLA 602b may be positioned along the optical axis 606 of the second ISLA 602b to form a second optical system 2312 in which light incident on the rear body lens 2308 is directed along the optical axis 606 to the image sensor 706 of the second ISLA 602b.

As shown, the front body lens 2306 may be spaced from the lens 704 of the first ISLA 602a along the optical axis 606 of the first ISLA 602a to define a front air gap 2314, and the rear body lens 2308 may be spaced from the lens 704 of the second ISLA 602b along the optical axis 606 of the second ISLA 602b to define a rear air gap 2316. As described previously, a size 2318 of the front air gap 2314—defined as the distance between lens 704 of the first ISLA 602a and the front body lens 2306 along the optical axis 606—may influence the optical characteristics of the first optical system 2310, such as by influencing the focal point of light that travels through the first optical system 2310. The size 2318 of the rear air gap 2316—defined as the distance between the lens 704 of the second ISLA 602b and the rear body lens 2308 along the optical axis 606—may similarly influence the optical characteristics of the second optical system 2312. Accordingly, nominal sizes for the front air gap 2314 and for the rear air gap 2316 may be established that result in nominal (e.g., optimal) optical characteristics for the first optical system 2310 and the second optical system 2312, respectively. Deviations from the nominal size of the front air gap 2314 and the rear air gap 2316—and thus the optical characteristics of the first optical system 2310 and the second optical system 2312—may thereby result in defects in the images captured by the image capture device 600 such as, for example, blurry images, distorted images, or the like. Furthermore, with respect to omnidirectional image capture devices that form combined images as described with respect to FIG. 3, the ability to stitch images from the first ISLA 602a and the second ISLA 602b to form the combined image may be impaired by deviations from the nominal size of the front air gap 2314 and/or the rear air gap 2316.

Many factors may cause deviations from the nominal size of the front air gap 2314 and the rear air gap 2316. For example, deviations from nominal dimensions of components that connect the lens 704 of the first ISLA 602a to the front body lens 2306 that result from manufacturing those components may cause the size 2318 of the front air gap 2314 to deviate from nominal. The magnitude of such deviations permitted by a manufacturing process may be referred to as a manufacturing tolerance. Manufacturing tolerances may be defined for different dimensions of the component. For example, a cylindrical component may have a different manufacturing tolerance for a diameter of the component (e.g., +/−0.1 mm) and for a length of the component (e.g., +/−0.4 mm). Because no known manufacturing process can repeatedly produce components that have perfectly nominal dimensions (e.g., no known manufacturing process can achieve zero tolerance), there will always be some deviation from the nominal dimensions of components that connect the lens 704 of the first ISLA 602a to the front body lens 2306.

Therefore, because each component that connects the lens 704 of the first ISLA 602a to the front body lens 2306 includes some manufacturing tolerance, the risk that the size 2318 of the front air gap 2314 will deviate from nominal will generally increase in proportion to the number of components that connect the lens 704 of the first ISLA 602a to the front body lens 2306. Similarly, the risk that the size 2318 of the rear air gap 2316 will deviate from nominal will also generally increase in proportion to the number of components that connect the lens 704 of the second ISLA 602b to the rear body lens 2308. The paths of components that connect the lens 704 of the first ISLA 602a to the front body lens 2306, and that connect the lens 704 of the second ISLA 602b to the rear body lens 2308, may be referred to as tolerance loops.

For example, a first tolerance loop 2320 is depicted in FIG. 23 as a bold line that extends from the lens 704 of the first ISLA 602a, through an inner component 2322 and an outer component 2324 of the housing 702 of the first ISLA 602a, through one of the fasteners 614 that connects the first ISLA 602a to the body 604, through a front internal support 2326 and a front lens support 2328 of the body 604, and to the front body lens 2306. The combined manufacturing tolerances of the components through which the first tolerance loop 2320 extends may be referred to herein as a first tolerance stack. Similarly, a second tolerance loop 2330 is depicted in FIG. 23 as another bold line that extends from the lens 704 of the second ISLA 602b, through the inner component 2322 and the outer component 2324 of the housing 702 of the second ISLA 602b, through the outer component 2324 of the housing 702 of the first ISLA 602a, through one of the fasteners 614 that connects the first ISLA 602a to the body 604, through the front internal support 2326, a first external component 2332, a second external component 2334, a rear internal support 2336, and a rear lens support 2338 of the body 604, and to the rear body lens 2308. The combined manufacturing tolerances of components through which the second tolerance loop 2330 extends may be referred to herein as a second tolerance stack.

In the above example, the first tolerance loop 2320 extends through five components and the second tolerance loop 2330 extends through eight components. Because the second tolerance loop 2330 extends through more components than the first tolerance loop 2320, the second tolerance stack will generally be larger than the first tolerance stack. Accordingly, the risk that the size 2318 of the rear air gap 2316 will deviate from nominal is generally greater than the risk that the size 2318 of the front air gap 2314 will deviate from nominal. Although specific components have been described through which the first tolerance loop 2320 and the second tolerance loop 2330 extend, this is only for the purposes of example and the first tolerance loop 2320 and the second tolerance loop 2330 may extend through more, less, and/or different components that as described herein.

Other sources of deviations from the nominal size of the front air gap 2314 and the rear air gap 2316 may include the placement of seals (e.g., the seal 1902) and/or other compliant materials (e.g., spring clips, etc.) between components through which the first tolerance loop 2320 and the second tolerance loop 2330 extend. Such seals and/or other compliant materials may vary in the magnitude at which they compress and may therefore cause inconsistent spacing of components between which they are positioned. This inconsistent spacing may cause deviations from the nominal size of the front air gap 2314 and the rear air gap 2316 similarly to as described above with respect to the manufacturing tolerances of components through which the first tolerance loop 2320 and the second tolerance loop 2330 extend.

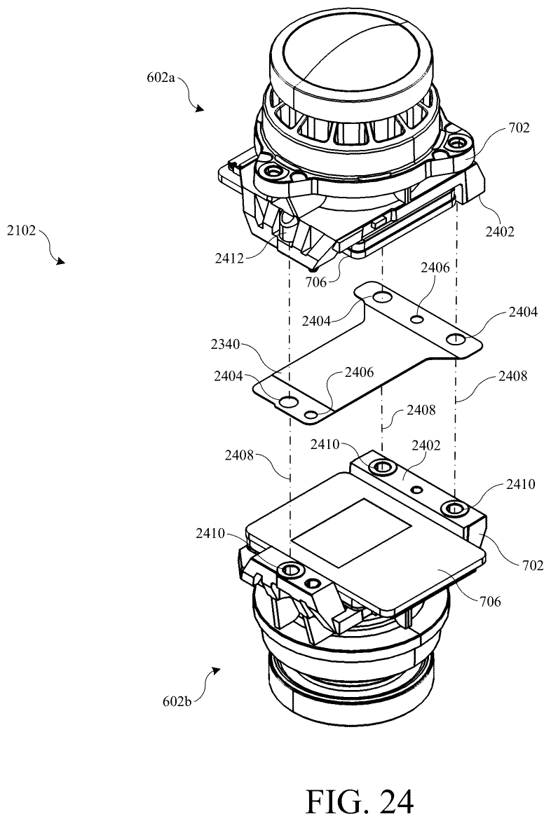

To adjust the size 2318 of the rear air gap 2316 toward nominal, a shim 2340 may be positioned between the first ISLA 602a and the second ISLA 602b that moves the second ISLA 602b, and the lens 704 thereof, toward the rear body lens 2308. For example, the shim 2340 may be positioned between (e.g., sandwiched between) mating surfaces (see FIG. 24) of the first ISLA 602a and the second ISLA 602b such as to space the housing 702 of the first ISLA 602a from the housing 702 of the second ISLA 602b along the common longitudinal axis 2110. By spacing the housing 702 of the first ISLA 602a from the housing 702 of the second ISLA 602b, the size 2318 of the rear air gap 2316 may be decreased to account for deviations resulting from the second tolerance stack. For example, one of the components through which the second tolerance loop 2330 extends (e.g., the first external component 2332 of the body 604) may be manufactured such as to be longer than nominal along the common longitudinal axis 2110, resulting in the size 2318 of the rear air gap 2316 being larger than nominal. In such an example, the shim 2340 may be positioned between the first ISLA 602a and the second ISLA 602b to reduce the size 2318 of the rear air gap 2316 toward nominal. Additionally or alternatively, an adhesive or some other material may be positioned between the first ISLA 602a and the second ISLA 602b that functions similarly to the shim 2340 to reduce the size 2318 of the rear air gap 2316 toward nominal. In some implementations, the shim 2340 may be the horizontal shield 2204 described with respect to FIGS. 22A-22B.

The sizes 2318 of the front air gap 2314 and the rear air gap 2316 may also have tolerances relative to the nominal size in which the optical characteristics of the first optical system 2310 and the second optical system 2312 are acceptable for operation of the image capture device 600. In some implementations, the tolerances of the front air gap 2314 and the rear air gap 2316 are each about +/−0.12 mm. In some implementations, the tolerances of the front air gap 2314 and the rear air gap 2316 are each in a range between about +/−0.8 mm and +/−0.16 mm. Furthermore, in some implementations, the tolerance of the rear air gap 2316 has a greater magnitude than the tolerance of the front air gap 2314.

FIG. 24 is an exploded view of the ISLA assembly 2102 and the shim 2340. As shown, the shim 2340 may be substantially planar. The shim 2340 may have any thickness that is suitable to adjust the size 2318 of the rear air gap 2316 toward nominal and/or within the tolerance of the rear air gap 2316. In some implementations, the shim 2340 may have a thickness that is in a range between about 120 μm and 225 μm. In some implementations, the shim 2340 may have a thickness that is in a range between about 60 μm and 450 μm. Although only one shim is shown in FIG. 24, multiple of the shims 2340 may be stacked to acquire a desired combined thickness.

The shim 2340 may be positioned between and contact each of a mating surface 2402 of the first ISLA 602a and the mating surface 2402 of the second ISLA 602b. In some implementations, the shim 2340 may be positioned parallel with and between the image sensor 706 of the first ISLA 602a and the image sensor 706 of the second ISLA 602b. As shown, the shim 2340 may include one or more coupling apertures 2404 (e.g., three of the coupling apertures 2404) and one or more locating apertures 2406 (e.g., two of the locating apertures 2406). The coupling apertures 2404 may be configured for fasteners (not shown) to extend therethrough for connecting the first ISLA 602a to the second ISLA 602b. For example, each of the fasteners may extend along a respective coupling axis 2408 through a respective coupling through-hole 2410 located on the housing 702 of the second ISLA 602b, through one of the coupling apertures 2404 of the shims 2340, and into a respective coupling boss 2412 located on the housing 702 of the first ISLA 602a to connect the first ISLA 602a to the second ISLA 602b, and to secure the shim 2340 therebetween.

The locating apertures 2406 of the shim 2340 may be configured to engage (e.g., receive) the locating members 2214 (see FIG. 22A) of the housing 702 of the first ISLA 602a. As explained with respect to FIGS. 22A-22B, the locating members 2214 of the housing 702 may extend from the housing 702 (e.g., from the mating surface 2402 of the housing 702). In addition to locating the shim 2340 to the housing 702 of the first ISLA 602a, the locating members 2214 of the housing 702 may also be configured to engage corresponding locating holes 2414 of the housing 702 of the second ISLA 602b to locate the first ISLA 602a to the second ISLA 602b. By adjusting the spacing between the first ISLA 602a and the second ISLA 602b, the shim 2340 may enable the rear air gap 2316 to be adjusted toward nominal and/or to be within the tolerance of the rear air gap 2316.

The methods and techniques of the ISLA attachment and shielding systems described herein, or aspects thereof, may be implemented by an image capture device, or one or more components thereof, such as the image capture device 100 shown in FIGS. 1A-1B, the image capture device 200 shown in FIGS. 2A-2B, the image capture device 300 shown in FIG. 3, the image capture device 400 shown in FIGS. 4A-4B, or the image capture device 500 shown in FIG. 5. The methods and techniques of the ISLA attachment and shielding systems described herein, or aspects thereof, may be implemented by an image capture device, such as the ISLA 104 shown in FIGS. 1A-1B, one or more of the ISLAs 204, 206 shown in FIGS. 2A-2B, one or more of the ISLAs 304, 306 shown in FIG. 3, the ISLA 404 shown in FIGS. 4A-4B, or an image capture device of the image capture device 500 shown in FIG. 5.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture device, comprising:
a body defining an interior and an exterior;
an image sensor and lens assembly (ISLA) located partly or entirely within the interior of the body, wherein the ISLA comprises a housing that extends from an image sensor to a lens to define an optical axis;
an insert that extends partially or entirely into the housing of the ISLA; and
a fastener configured to extend from the exterior of the body in a direction parallel with the optical axis and engage the insert to connect the ISLA to the body.

2. The image capture device of claim 1, wherein the fastener is a threaded fastener, and wherein the insert engages the housing of the ISLA to inhibit rotation of the insert.

3. The image capture device of claim 2, wherein the insert is pressed fit into an aperture located on the housing of the ISLA to inhibit rotation of the insert.

4. The image capture device of claim 2, wherein the insert comprises a series of ribs that extend radially outward from an outer surface of the insert, and wherein the ribs engage the housing of the ISLA to inhibit rotation of the insert.

5. The image capture device of claim 4, wherein the ribs are parallel with a longitudinal axis of the insert.

6. The image capture device of claim 1, wherein the insert extends partially or entirely through an aperture located on the housing, and the insert comprises a flange that is located on a rear surface of the housing of the ISLA.

7. The image capture device of claim 1, wherein the insert comprises a first material and the housing of the ISLA comprises a second material that different than the first material.

8. The image capture device of claim 1, further comprising:
a bayonet located on the exterior of the housing, wherein the fastener is further configured to extend through the bayonet.

9. The image capture device of claim 1, wherein the insert is one of multiple inserts that are spaced around the optical axis, and wherein the fastener is one of multiple fasteners that are each configured to extend from the exterior of the body in the direction parallel with the optical axis and engage respective ones of the inserts to connect the ISLA to the body.

10. An image capture device, comprising:
a body;
an image sensor and lens assembly (ISLA) located either partly or entirely within an interior of the body, wherein the ISLA comprises a housing that includes a rear surface; and
a fastener configured to extend from an exterior of the body, through the housing to engage an insert located on the rear surface of the housing to connect the housing to the body,
wherein the housing of the ISLA includes an anti-rotation device that is configured to receive and inhibit rotation of the insert.

11. The image capture device of claim 10, wherein the fastener is one of multiple fasteners that are each configured to extend from the exterior of the body and through the housing to engage a respective insert located on the rear surface of the housing to connect the ISLA to the body, and wherein the anti-rotation device is one of multiple anti-rotation devices that are each configured to receive and inhibit rotation of a respective insert.

12. The image capture device of claim 11, wherein the anti-rotation devices are separate from the housing of the ISLA and are connectable to the rear surface of the housing.

13. The image capture device of claim 12, wherein the anti-rotation devices are bonded to the rear surface of the housing.

14. The image capture device of claim 11, wherein the anti-rotation devices and the housing are unitarily formed.

15. The image capture device of claim 10, further comprising:
a bayonet located on the exterior of the housing, wherein the fastener is configured to extend through the bayonet.

16. The image capture device of claim 10, wherein the housing of the ISLA supports a lens and an image sensor along an optical axis, and wherein the fastener is configured to extend from the exterior of the body and through the housing in a direction parallel with the optical axis.

17. An attachment system, comprising:
an image capture device, comprising:
a body;
an image sensor and lens assembly (ISLA) configured to be secured within the body, wherein the ISLA comprises a housing that includes a rear surface; and
an insert positionable on the rear surface of the housing, wherein the insert is configured to receive a fastener that extends from an exterior of the body and through the housing to secure the ISLA within the body; and
an anti-rotation device positionable on the rear surface of the housing to receive and inhibit rotation of the insert.

18. The attachment system of claim 17, wherein:
the ISLA includes an image sensor and a lens that are positioned along an optical axis,
the insert is one of multiple inserts that are each configured to receive a respective fastener that extends from the exterior of the body and through the housing in a direction parallel with the optical axis; and
the anti-rotation device is positionable on the rear surface of the housing to receive and inhibit rotation of the inserts.

19. The attachment system of claim 18, further comprising a bayonet positioned on the exterior of the body along the optical axis, wherein the fastener extends through the bayonet.

20. The attachment system of claim 17, wherein the anti-rotation device comprises:
a handle; and
an anti-rotation member configured to receive and inhibit rotation of the insert, wherein the handle is severable from the anti-rotation member.
